(19) United States
(12) Patent Application Publication
(10) Pub. No.: US 2004/0088792 A1
(43) Pub. Date: May 13, 2004

(54) Transportatable medical apparatus

(76) Inventors: Jason M. O'Krangley, Caledonia, MI (US); David M. Kruithoff, Grand Rapids, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 10/652,671

(22) Filed: Aug. 29, 2003

Related U.S. Application Data
(60) Provisional application No. 60/407,348, filed on Aug. 30, 2002.

(51) Int. Cl. A61G 7/012

(52) U.S. Cl. 5/611

(57) ABSTRACT

An undercarriage for transporting a stretcher includes a support base, which is adapted for supporting a stretcher, a first pair of legs pivotally mounted to the support base, and a second pair of legs pivotally and slidably mounted to the support base. The first pair of legs is independently pivotal about the support base from the second pair of legs. In addition, a journaled member is provided at the distal ends of each leg. The undercarriage also includes a control system that is adapted to selectively pivot the first pair of legs to a stowed position and to selectively pivot the second pair of legs to a stowed position. The control system is further adapted to selectively lengthen or shorten the legs to adjust the height of the support base.

This application claims priority from provisional application entitled TRANSPORTABLE MEDICAL APPARATUS, Ser. No. 60/407,348, filed Aug. 30, 2002, which is incorporated herein by reference in its entirety.

### TECHNICAL FIELD AND BACKGROUND OF THE INVENTION

The present invention is generally directed to a transportation device for transporting a person, especially in a medical situation.

Transportation equipment for patients, such as cots or stretchers, which are used to transport a patient in a vehicle, such as an ambulance or aircraft, including a helicopter, are well known. Most equipment of this type include a wheeled undercarriage and a stretcher that is removably mounted to the undercarriage. The equipment, however, is relatively heavy and cumbersome to handle. As a result, the equipment usually requires two or more persons to load the equipment onto the vehicle. Furthermore, the equipment is typically not adjustable and, therefore, cannot readily adapt to the needs of the persons, most often paramedics, who handle the equipment.

Consequently, there is a need for a patient transportation device that can facilitate loading of the device onto a vehicle, including an aircraft, such as a helicopter, and can provide adjustment so that it may be adjusted to the needs of the person handling the device.

### SUMMARY OF THE INVENTION

Accordingly, the present invention provides an undercarriage for transporting a stretcher, which includes a support base that is adapted for supporting a stretcher and first and second pairs of legs, which are pivotally mounted to the support base, with each leg including a journaled member to permit the undercarriage to be moved across a support surface, such as the ground, a floor, or the like. The second pair of legs is slidably mounted to the base and is independently pivotal about the support base from the first pair of legs. The undercarriage further includes a control system that is adapted to selectively pivot the legs to stowed positions and, further, adapted to selectively lengthen or shorten the legs to adjust the height of the support base.

In one aspect, the stowed position of the first pair of legs is located between the upper surface and the lower surface of the support base to thereby provide a compact arrangement. In another aspect, the stowed position of the second pair of legs is between the upper and lower surfaces of the support base. For example, the second pair of legs may be at least partially extended into the support base when moved to their stowed position to thereby provide a compact undercarriage.

According to yet another aspect, the support base includes a plurality of journaled members that enable a person to translate the undercarriage across the support surface when the first pair of legs are pivoted to their stowed position and also when the second pair of legs are pivoted to their stowed position. The journaled members preferably include at least one pair of forward journaled members to provide support to the support base when the support base is initially loaded onto the support surface and the forward legs are at least initially pivoted. In addition, another group of the journaled members of the support base are preferably located forward of the rearward legs and rearward of the forward legs to form intermediate journaled members such that the intermediate journaled members provide support for the undercarriage when the forward legs are fully pivoted to their stowed position to thereby ease handling of the undercarriage. For example, the intermediate journaled members may be located at or near the center of gravity of the undercarriage and are optionally located rearward of the center of gravity.

According to other aspects, the control system includes a plurality of cylinders that pivot and adjust the length of the legs. For example, the cylinders may comprise hydraulic cylinders. Furthermore, each of the legs preferably includes a pivot cylinder and a height adjustment cylinder, wherein the pivoting and the height adjusting is independent. In order to maintain the level of the support base, the adjustment cylinders are preferably coupled. In the case where the cylinders comprise hydraulic cylinders, the cylinders may be hydraulically coupled.

Accordingly, the present invention provides an undercarriage for transporting a stretcher, which facilitates loading of the stretcher into a vehicle, including an aircraft, such as a helicopter, and, further, can provide adjustment so that the height of the support base may be adjusted to the needs of the person handling the undercarriage.

These and other objects, advantages, purposes, and features of the invention will become more apparent from the study of the following description taken in conjunction with the drawings.

### BRIEF DESCRIPTION OF THE DRAWINGS

FIG. 1 is a perspective view of an undercarriage of a transportation device of the present invention;

FIG. 2 is a side perspective view of the undercarriage of FIG. 1 illustrating the forward legs of the undercarriage in a partially pivoted position;

FIG. 3 is a similar view to FIG. 2 with the rearward legs partially pivoted;

FIG. 4 is a side elevation view of the undercarriage illustrating the legs in a lowered position;

FIG. 5 is a side perspective view of the undercarriage of FIG. 1 being loaded onto a vehicle illustrating the forward legs pivoting to a stowed position;

FIG. 6 is a similar view to FIG. 5 illustrating the forward legs fully pivoted to their stowed position;

FIG. 7 is a similar view to FIG. 6 illustrating the rearward legs pivoted to their stowed position;

FIG. 8 is a top view of the undercarriage of FIG. 1 in a stowed configuration with the legs in their fully pivoted and stowed positions;

FIG. 9 is a perspective view of the undercarriage illustrating the legs in an extended configuration;

FIG. 10 is a front perspective view of the undercarriage of FIG. 1;

FIG. 11 is a rearward end elevation view of the undercarriage of FIG. 1;

FIG. 12 is an enlarged partial plan view illustrating the mounting arrangement of the control system of the undercarriage;

FIG. 13 is an enlarged partial plan view of the mounting arrangement of the control system, the rearward legs, and a release mechanism of the present invention;

FIG. 14 is a partial plan view of the undercarriage of FIG. 1 illustrating the mounting arrangement of the control system and intermediate support wheels;

FIG. 15 is an enlarged rear end perspective view of the telescoping arrangement of the forward and rearward legs of the undercarriage of FIG. 1;

FIG. 16 is an enlarged plan view of the telescoping arrangement of the rearward legs of the undercarriage;

FIG. 17 is an enlarged partial plan view of the mounting arrangement of the control system of the present invention;

FIG. 18 is an enlarged partial perspective view of the mounting arrangement of the control system of the present invention;

FIG. 19 is another enlarged partial perspective view of the mounting arrangement of the control system of the present invention;

FIG. 20 is a side elevation view of the undercarriage of FIG. 1 with the details of the control system removed for clarity;

FIG. 20A is an enlarged view of a linear rail and guide;

FIG. 20B is a cross-section taken along line XXB-XXB of FIG. 20A;

FIG. 20C is a rear elevation view of the undercarriage of FIG. 20 with several details removed to illustrate a rearward axial locking mechanism;

FIG. 20D is an enlarged side view of the rearward axial locking mechanism with several details removed for clarity;

FIG. 21 is a side elevation view of the undercarriage of FIG. 20 illustrating the undercarriage being loaded onto a support surface with the forward wheels being pivoted to a stowed position;

FIG. 22 is a similar view to FIG. 21 with the rearward wheels fully pivoted to their stowed position and the undercarriage partially loaded onto the support surface;

FIG. 23 is a similar view to FIG. 21 illustrating the undercarriage fully loaded onto the support surface;

FIG. 24 is a plan view of the undercarriage of FIGS. 20-23 illustrating the forward legs pivoted to their stowed position;

FIG. 25 is a similar view to FIG. 24 illustrating the forward legs and rearward legs pivoted to their stowed position;

FIG. 26 is a schematic view of the control system of the undercarriage of the present invention;

FIG. 27 is a schematic view of a circuit of the control system of the present invention;

FIG. 27A is an enlarged schematic view of a quick disconnect of the control system;

FIG. 28 is an enlarged plan view of the locking mechanism of the undercarriage; and

FIG. 29 is an exploded plan view of the locking mechanism of FIG. 28.

### DETAILED DESCRIPTION OF THE PREFERRED EMBODIMENTS

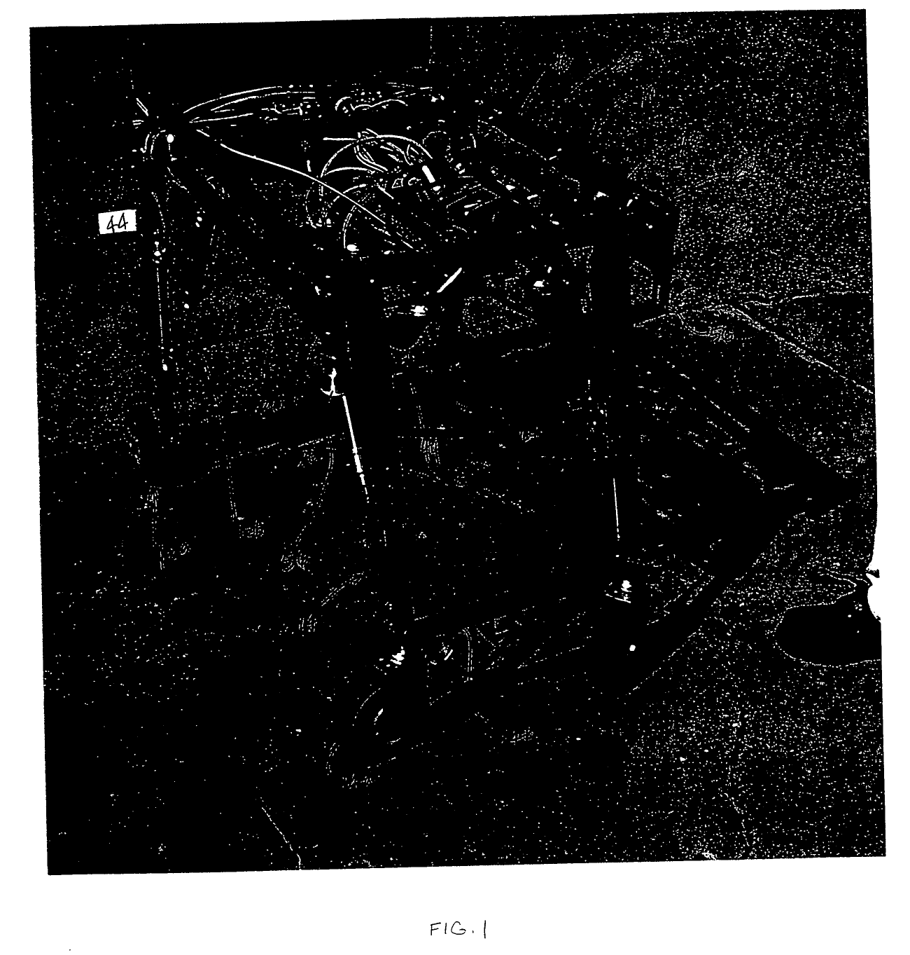

Referring to FIG. 1, the numeral 10 generally designates an undercarriage of the present invention. Undercarriage 10 is particularly suitable for use in transporting a stretcher (not shown) and for loading the stretcher onto a vehicle, including an aircraft, such as a helicopter. As will be more fully described below, undercarriage 10 includes a support base 18, a forward pair of legs 12, and a rearward pair of legs 14, which are pivotally mounted to support base 18 and are selectively pivoted to stowed positions so that undercarriage 10 can be loaded onto the vehicle (not shown). In addition, undercarriage 10 includes a control system 16 that enables the person loading the undercarriage to control the pivoting of the respective legs and, further, to raise and lower the height of the support base 18 to ease handling of undercarriage 10. As will be appreciated from the following description, support base 18 is configured and legs 12 and 14 are pivoted in a manner to permit a single person, such as a paramedic, to load the undercarriage and stretcher onto a vehicle.

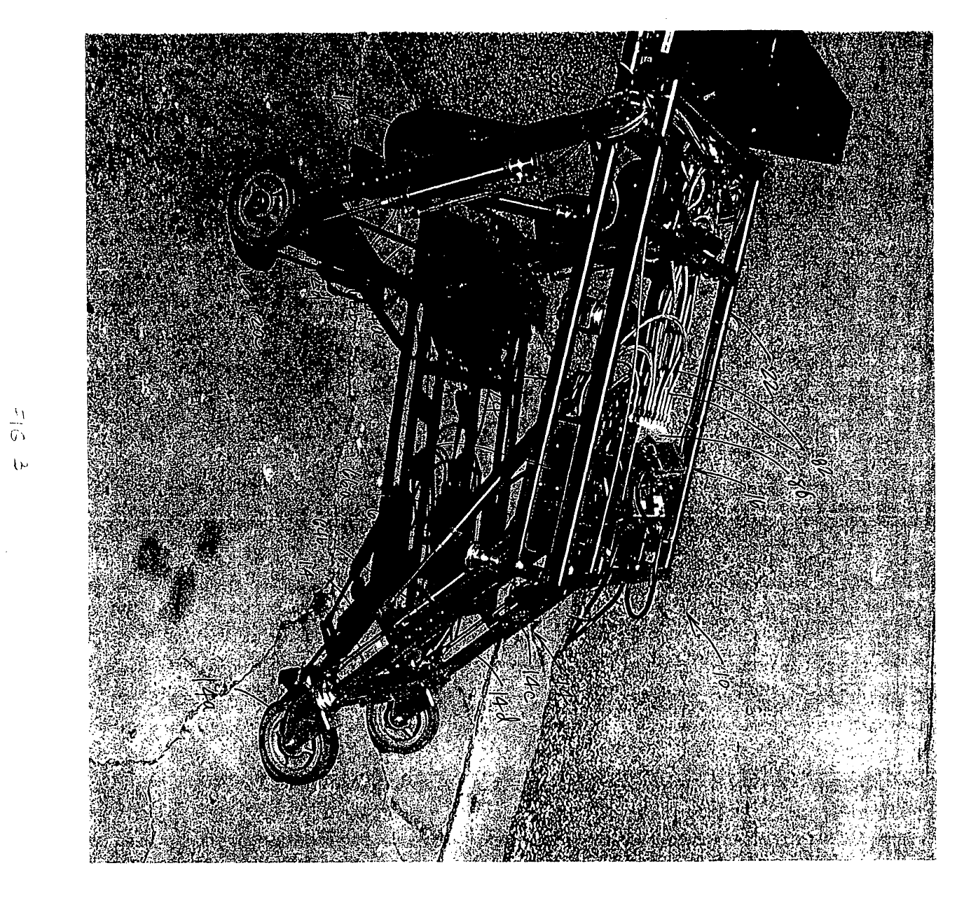

Support base 18 is adapted to releasably mount to a stretcher inside the base of the stretcher. Referring to FIGS. 1-4, support base 18 is formed from a plurality of horizontally arranged structural members 20, such as tubular members, that are interconnected, for example by welding, to form an upper frame 22 and a lower frame 24. In the illustrated embodiment members 20 comprise stainless steel tubular members and are interconnected by welding; however, it should be appreciated that other structural members and other methods of connection may be used. Upper frame 22 and lower frame 24 are interconnected by vertical frame members 26 and 28 to form an open frame with a compartment in which at least some of the components of control system 16 may be mounted and, further, into which rear legs 14 may be stowed, as will be more fully described below.

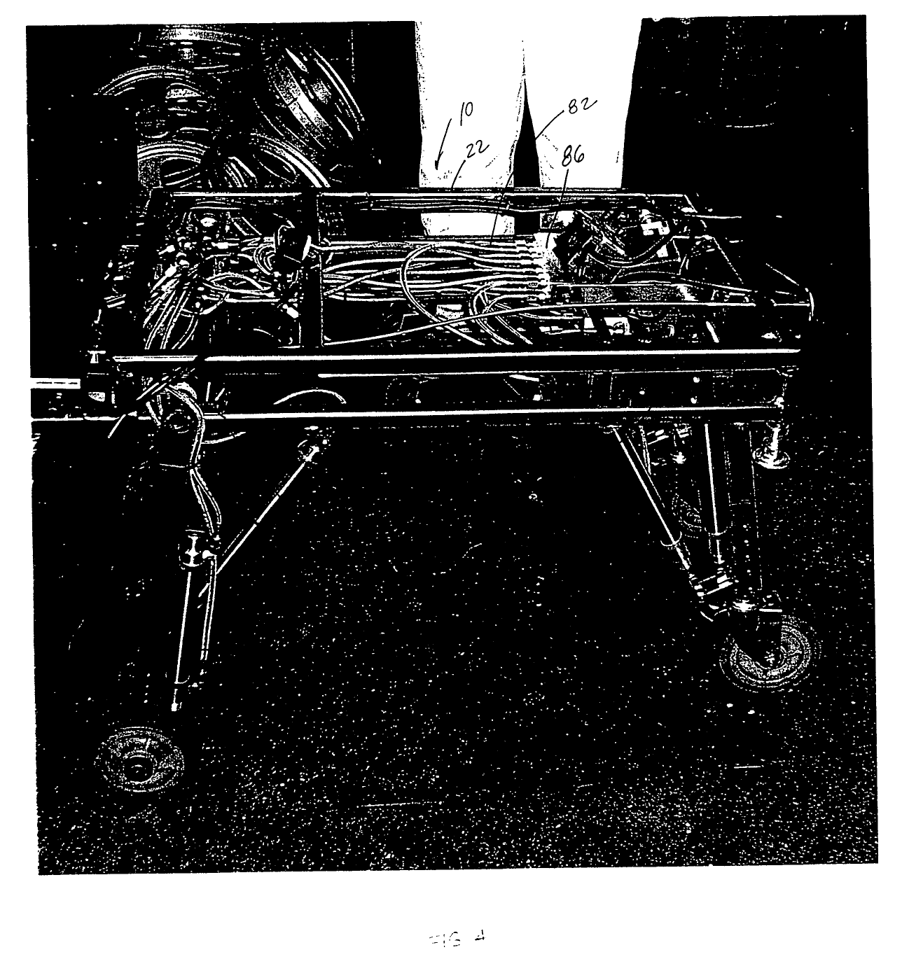

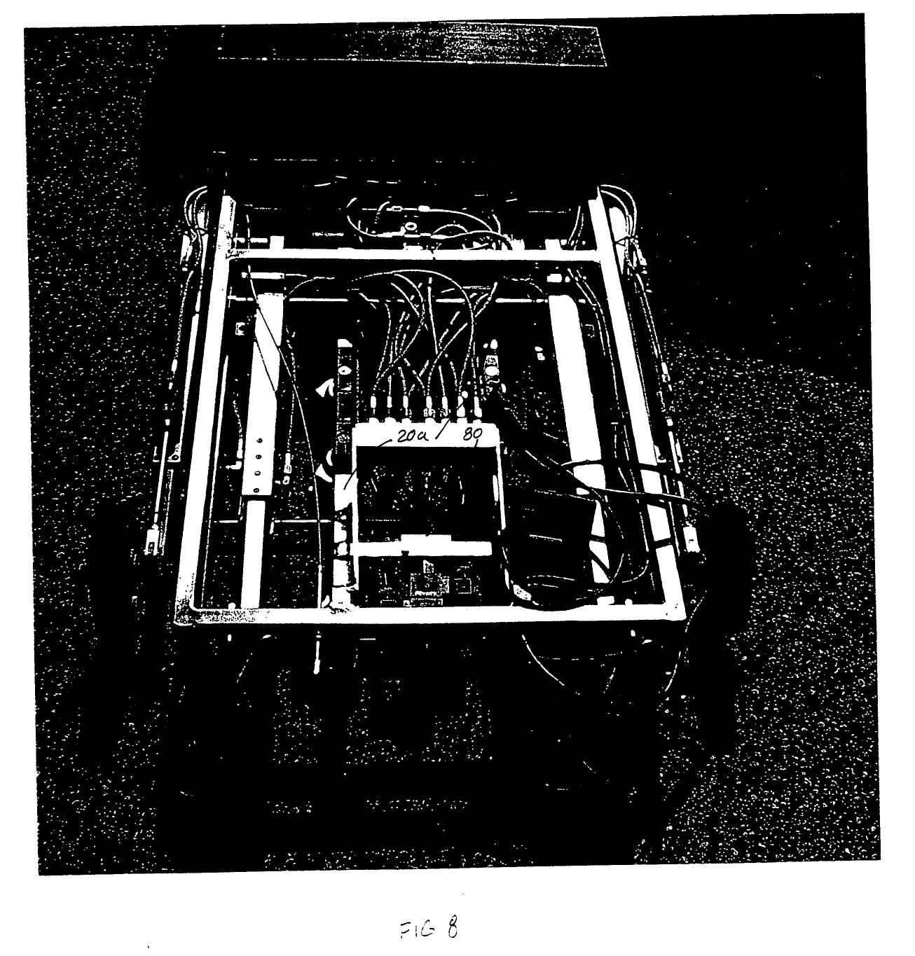

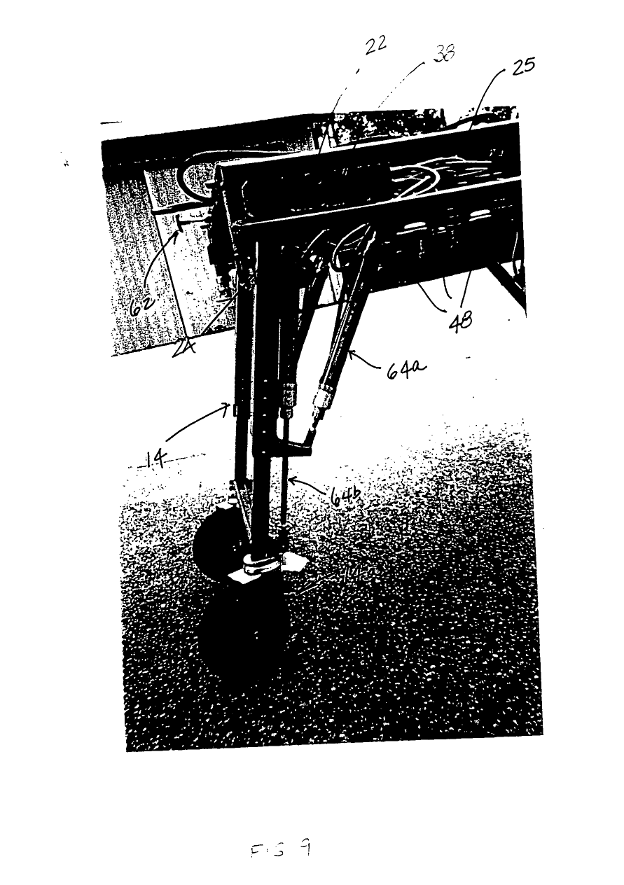

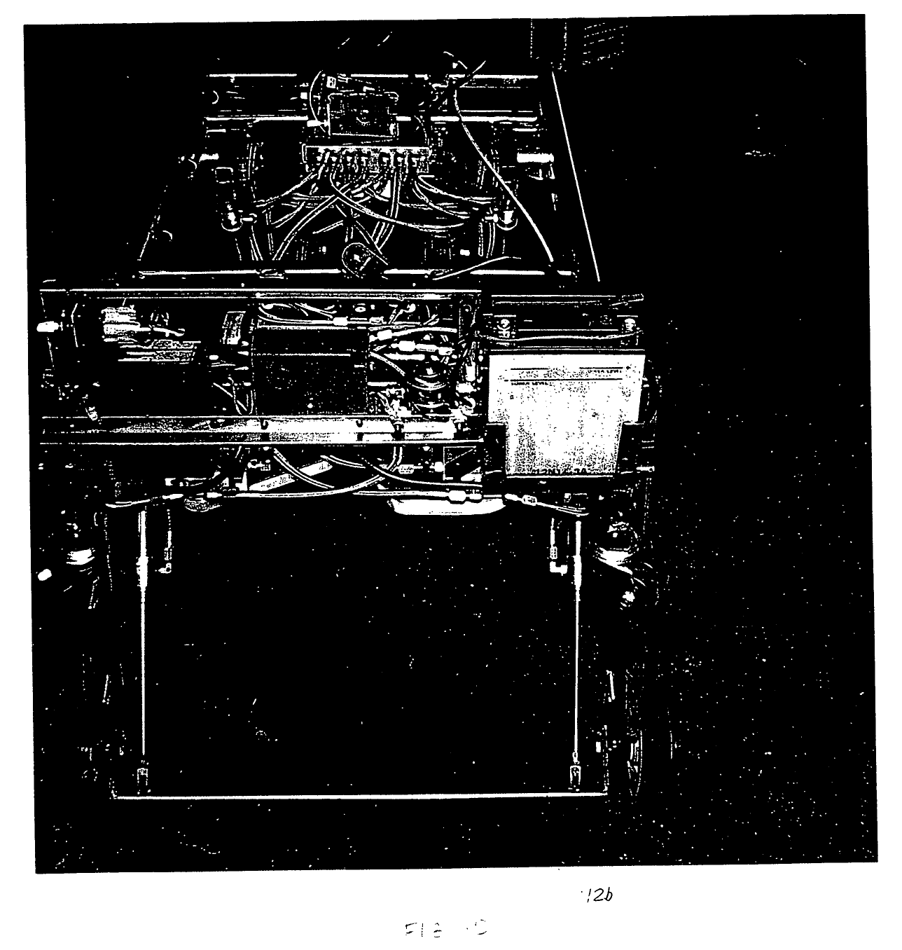

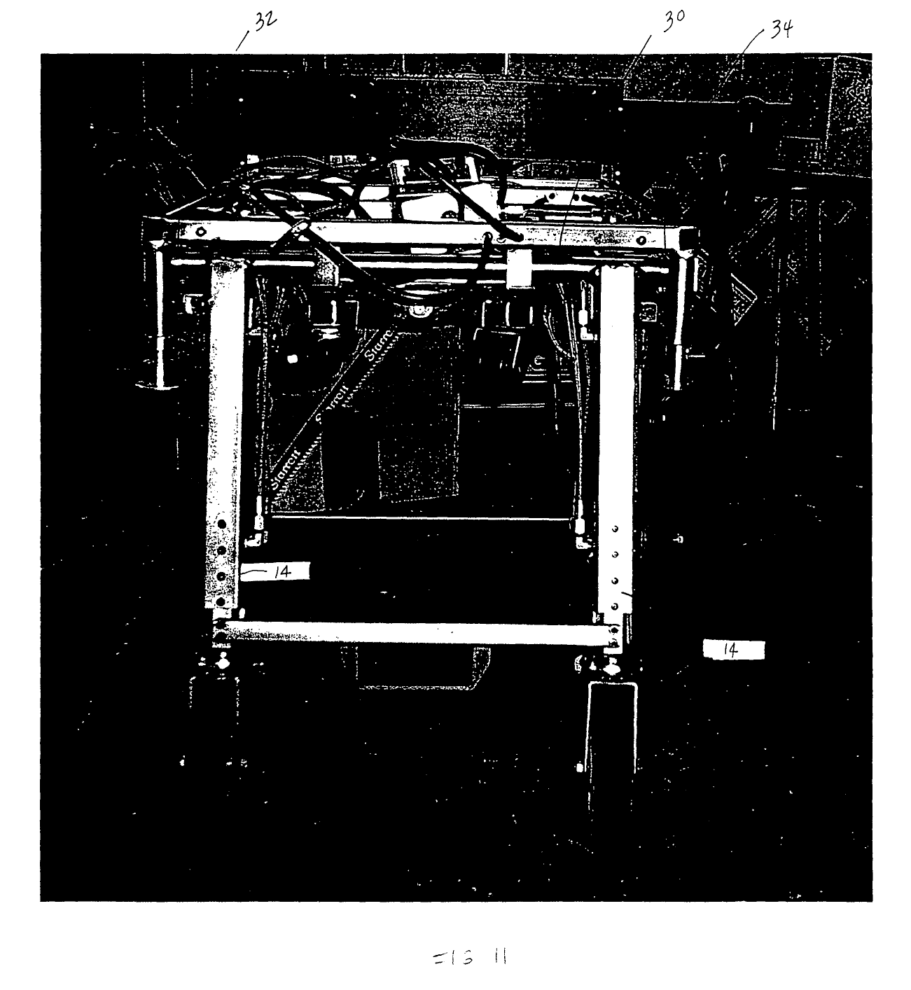

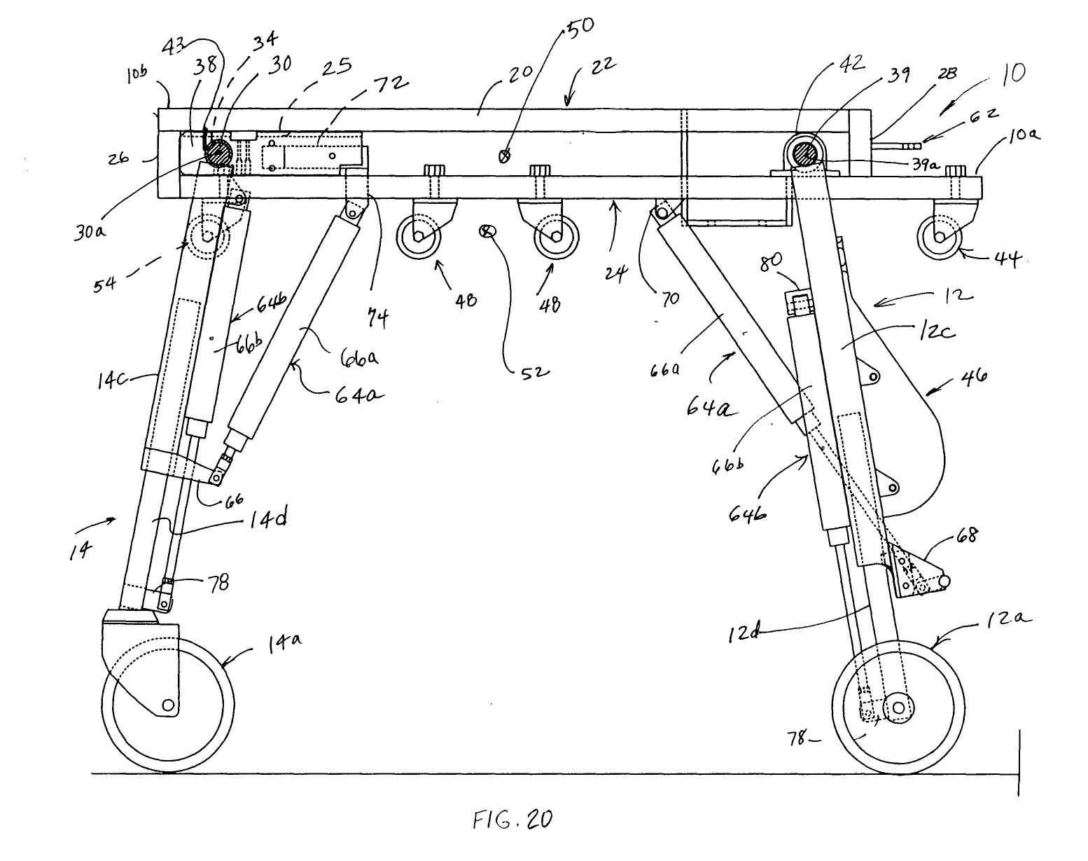

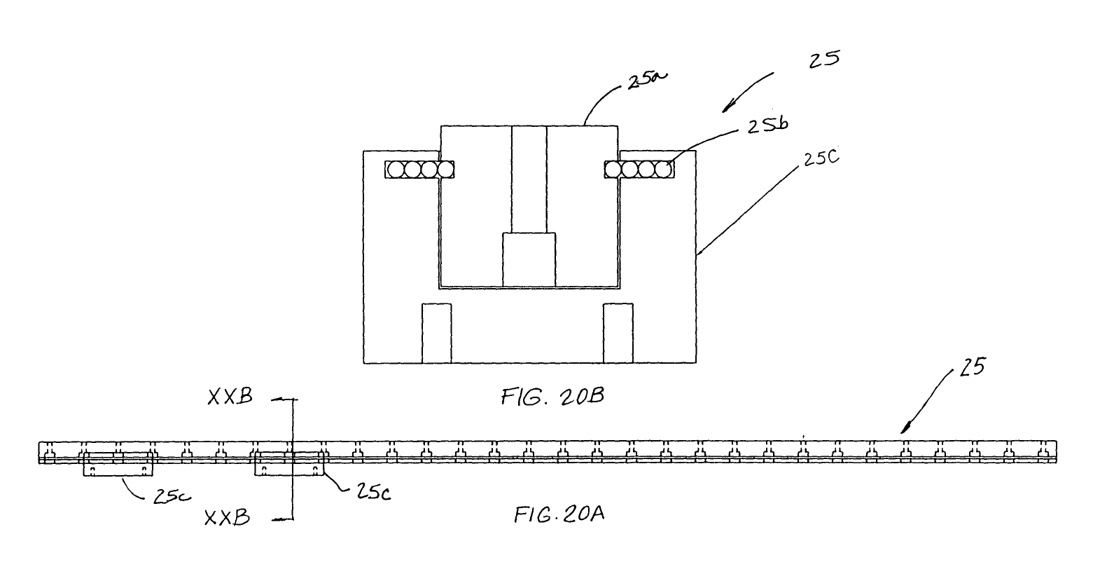

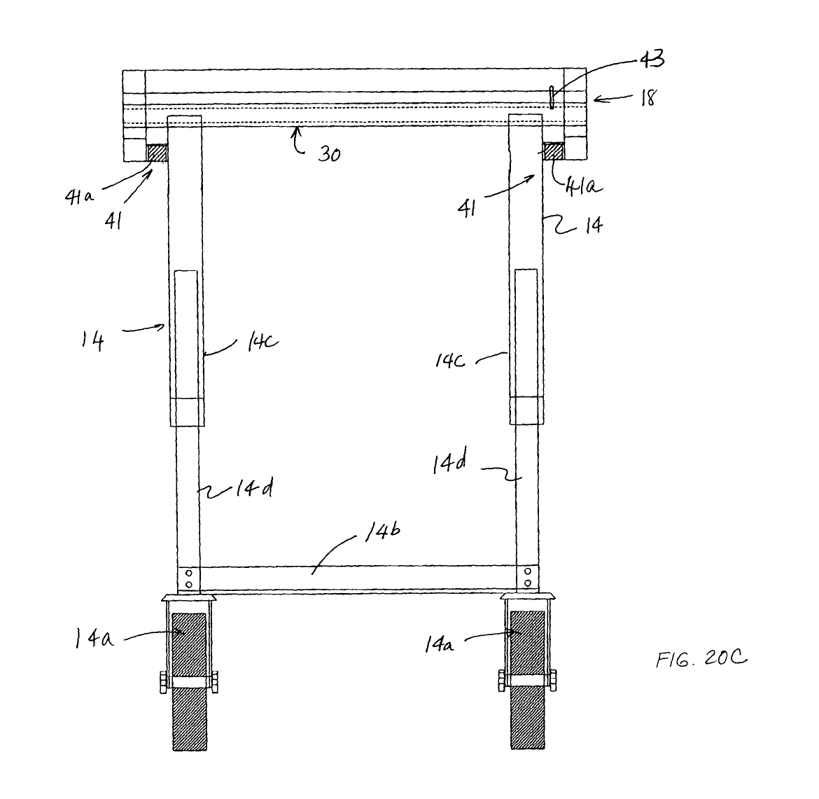

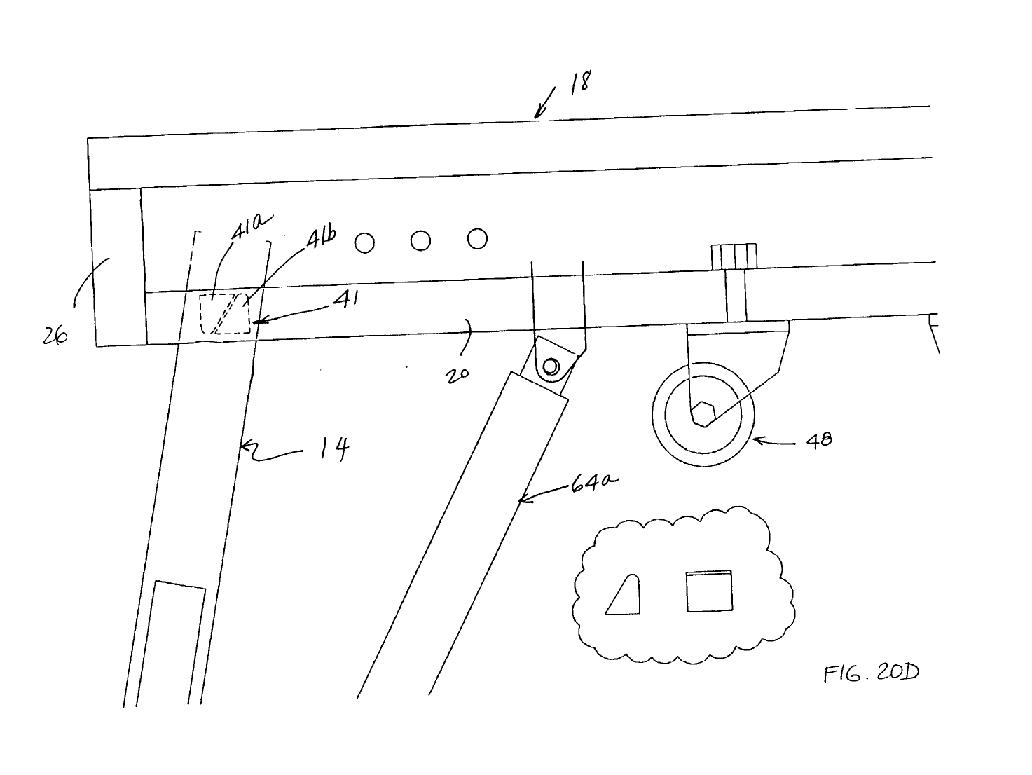

In the illustrated embodiment, lower frame 24 provides a mounting surface for forward and rearward pivotal legs 12 and 14. Furthermore, each leg 12, 14 includes a journaled member 12a, 14a, such as a wheel, roller, caster, or the like, to permit undercarriage 10 to be moved relative to a support surface, such as the ground or floor of a hospital or the like, when the legs are in their operative, lowered positions. As best seen in FIGS. 11 and 20, rearward legs 14 are pivotally mounted to support base 18 by a transverse shaft or axle 30, which is journaled in collars 32 and 34. The distal ends of rearward legs 14 are interconnected by a brace 14b (FIG. 1), while the proximal ends of rearward legs 14 are rigidly mounted to shaft 30; therefore, legs 14 rotate in unison along with shaft 30 about pivot axis 30a. Collars 32 and 34 are mounted to brackets 36 and 38 (FIGS. 4, 9, and 20), which in turn are mounted between upper frame 22 and lower frame 24. Brackets 36 and 38 comprise plate brackets and are supported for linear movement along support base 18 between upper and lower frames 22 and 24 on linear motion bearing assemblies 25 (FIGS. 9, 20A, and 20B) that are mounted to horizontal members 20 of upper and lower frames 22, 24 so that when rearward legs 14 are fully pivoted, legs 14 can be retracted into support base 18 in to the open compartment defined by upper and lower frames 22 and 24 to provide a compact undercarriage when the undercarriage is loaded onto a support surface (FIG. 8). As will be more fully described below, brackets 36 and 38 also provide a mounting surface for the respective pivot actuators for rearward legs 14.

As best seen in FIGS. 20A and 20B, each linear motion bearing assembly 25 includes a rail 25a, which is mounted to a respective horizontal member (20), and a plurality of bearings 25b that extend along both sides of rail 25a and on which guides 25c are mounted for linear movement along bearings 25b and, hence, rail 25a. Brackets 36 and 38 are mounted to bearing assemblies 25 by guides 25c, which support brackets 36 and 38 for linear movement along base 18.

In order to prevent brackets 36 and 38 from moving along support base 18 when rearward legs 14 are in their extended or supporting position, undercarriage 10 incorporates locking mechanisms 41 (FIG. 20C). As best seen in FIGS. 20C and 20D, each locking mechanism 41 includes a first stop 41a, which is mounted to the upper end of a respective rearward leg, and a second stop 41b, which is mounted to support base 18. Stops 41a and 41b make contact with each other when rearward legs 14 are extended and, thus, prevent the upper ends of legs translating linearly with respect to base 18. In addition, stops 41a and 41b prevent further rotation of legs in a counterclockwise direction (as viewed in FIG. 20) to thereby effectively lock legs 14 in position when they are rotated to their operative or supporting positions. In addition, control system 16 preferably includes a safety switch 43 to prevent activation of rearward legs 14 until axle 30 of rearward legs 14 is in its fully extended rearward position in base 18. Referring to FIGS. 20 and 20C, switch 43 is mounted to base 18 and positioned so that when axle 30 is moved to its fully extended rearward position, axle 30 will trigger switch 43. For example, switch 43 may comprise a limit switch or the like.

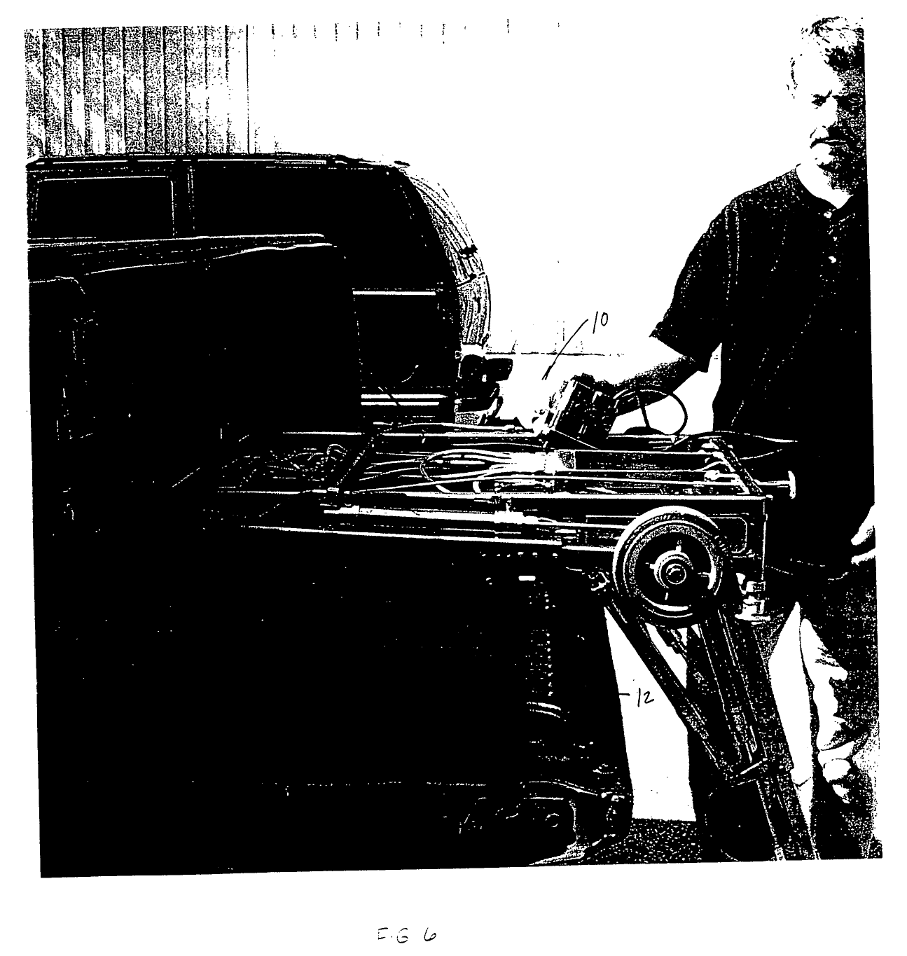

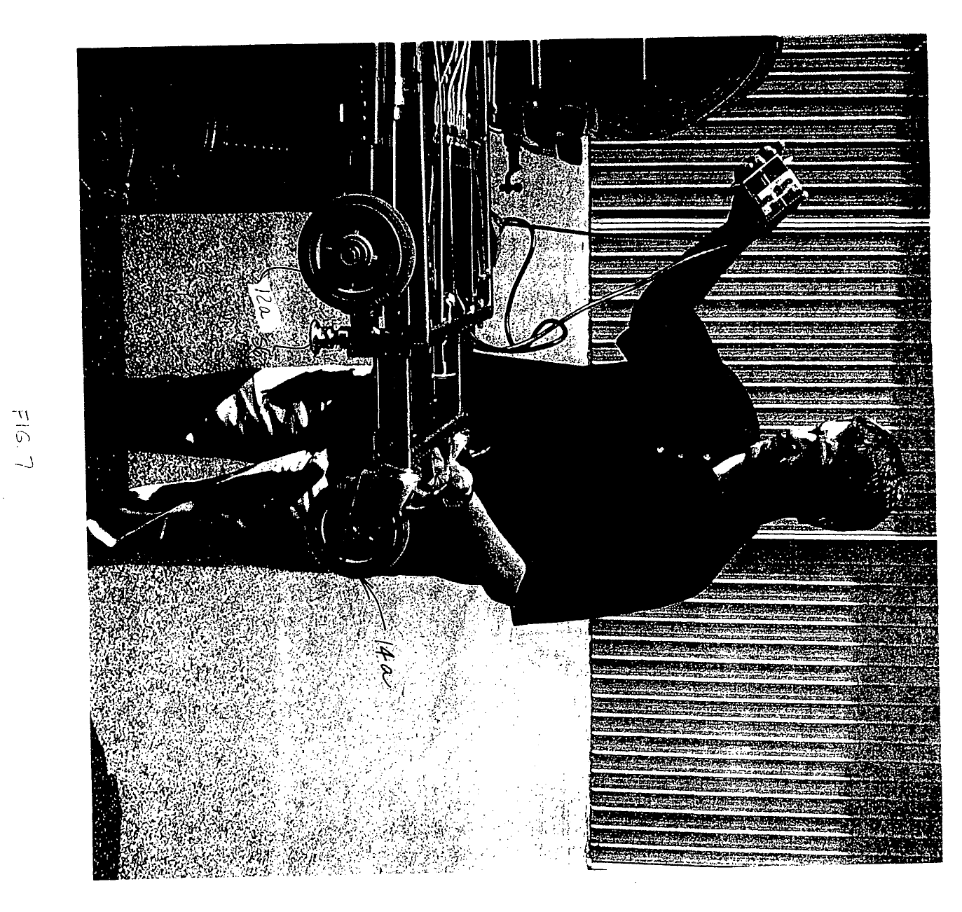

Forward legs 12 are similarly mounted at their proximal ends to a shaft axle 39, which is pivotally mounted to support base 18 by brackets 40 (FIG. 4) and 42 (FIG. 20), and are interconnected at a medial portion by a brace 12b (FIG. 1). Therefore, legs 12 similarly pivot in unison about the pivot axis 39a with shaft 39. Brackets 40 and 42 are mounted to horizontal members 20 of lower frame 24 at an opposed end of support base 18 from legs 14 to provide together with legs 14 wheeled support for support base 18. Brackets 40 and 42 comprise conventional C-shaped brackets with mounting flanges that are either bolted or welded to a respective horizontal member 20. Referring to FIGS. 6 and 8, when legs 12 are fully pivoted to their stowed position, legs 12 lie in a plane generally parallel to horizontal members 20 of support base 18 between upper and lower frames 22 and 24 but adjacent frames 22 and 24 and, further, between the upper plane bounded by the upper surface of upper frame 22 and the lower plane bounded by the lower surface of lower frame 24, with the exception of the journaled member that may be of a size to project below the lower frame 22.

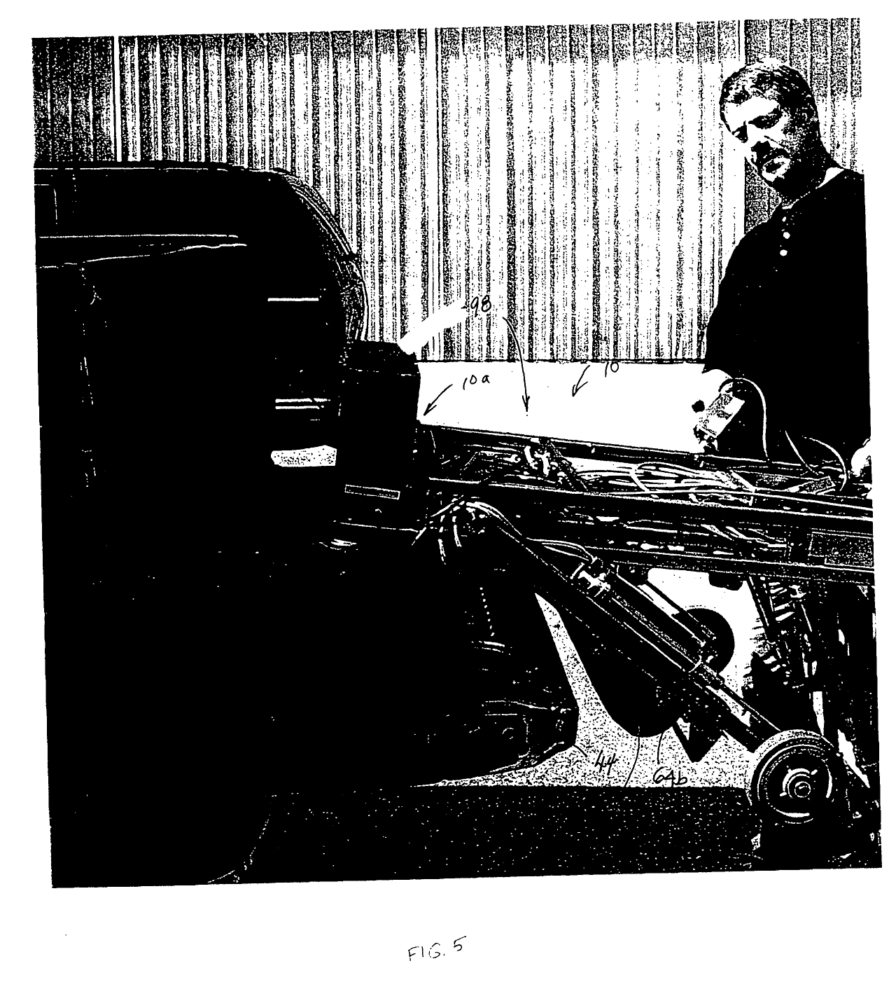

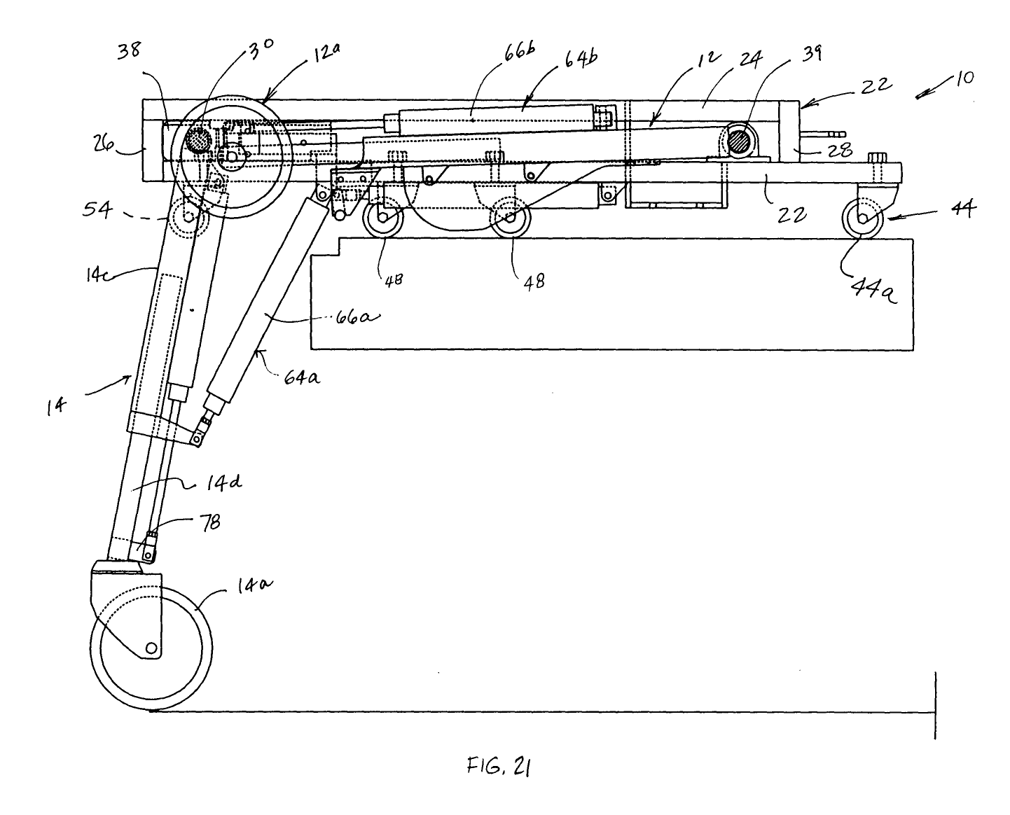

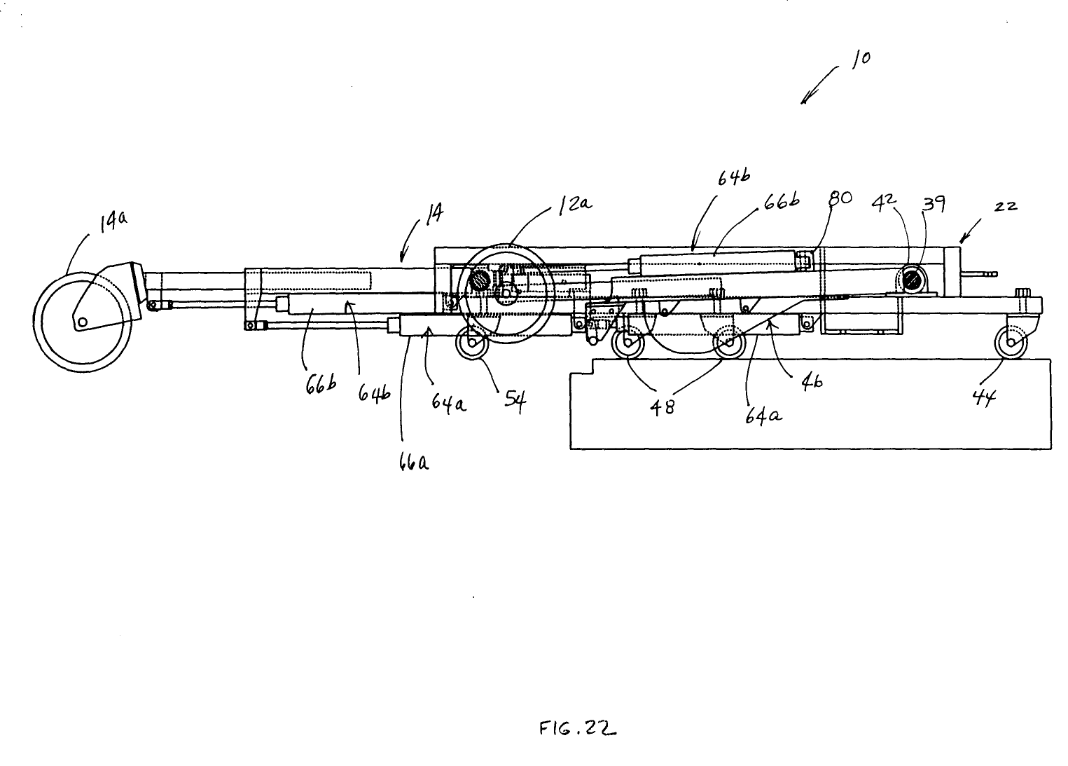

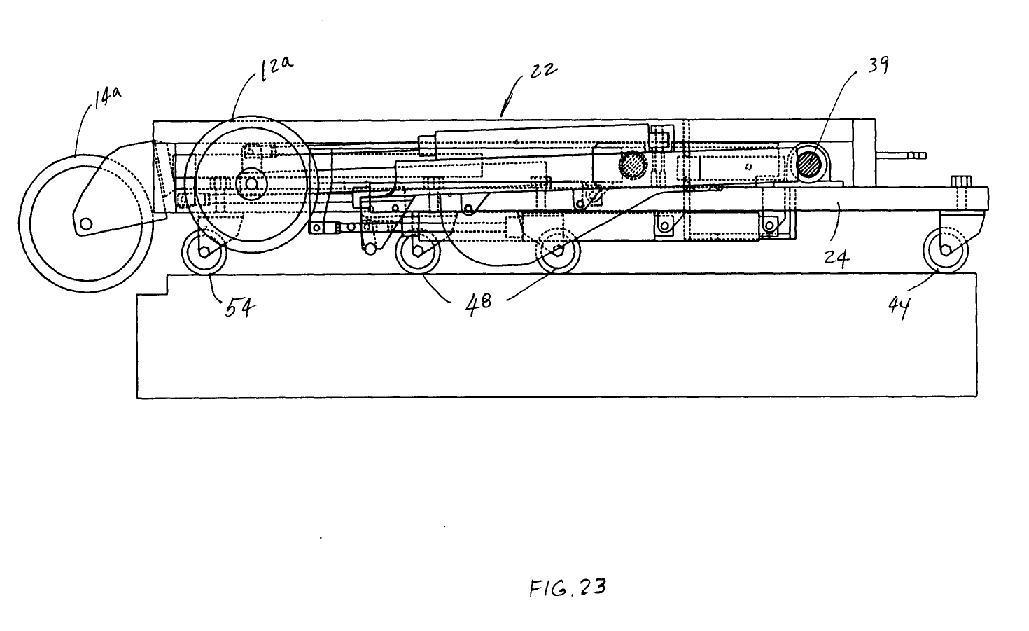

As best understood from FIGS. 5 and 21, to transfer undercarriage 10 onto a support surface, such as the floor of vehicle, including a helicopter, forward portion 10a of the undercarriage is first moved toward the support surface so that it extends over the support surface. The forward portion of support base 18 includes front or forward journaled guide members 44, such as wheels, rollers, casters or the like, that are mounted to the horizontal members 20 of lower frame 24, preferably with a swivel mount. Once guide members 44 are resting on the support surface, the forward legs 12 may then be pivoted. As the forward legs pivot, the undercarriage can be pushed onto the support surface from the rear end of the undercarriage. This can be managed by one person, unlike the prior art devices. To facilitate the further rotation of the front legs, front legs 12 include flanges or cam members 46 that act as a guide when they contact the support surface and apply an upward force to the front legs as the undercarriage is pushed on to the support surface. Flanges or cam members 46 are preferably formed from low friction material, such as plastic plates, that are mounted to the respective upper tubular members of the forward legs and are oriented to face forward toward the support surface. As the forward legs continue to pivot, the person handling the undercarriage can continue to urge the undercarriage forward on to the support surface.

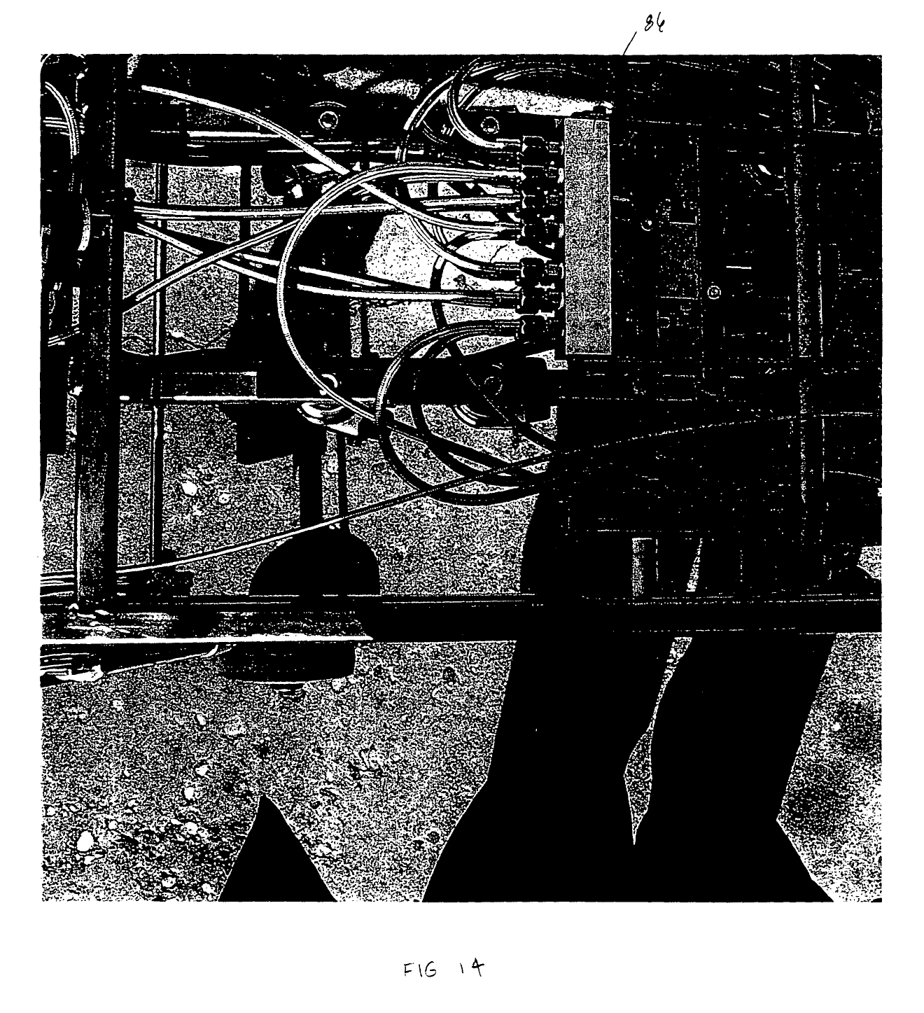

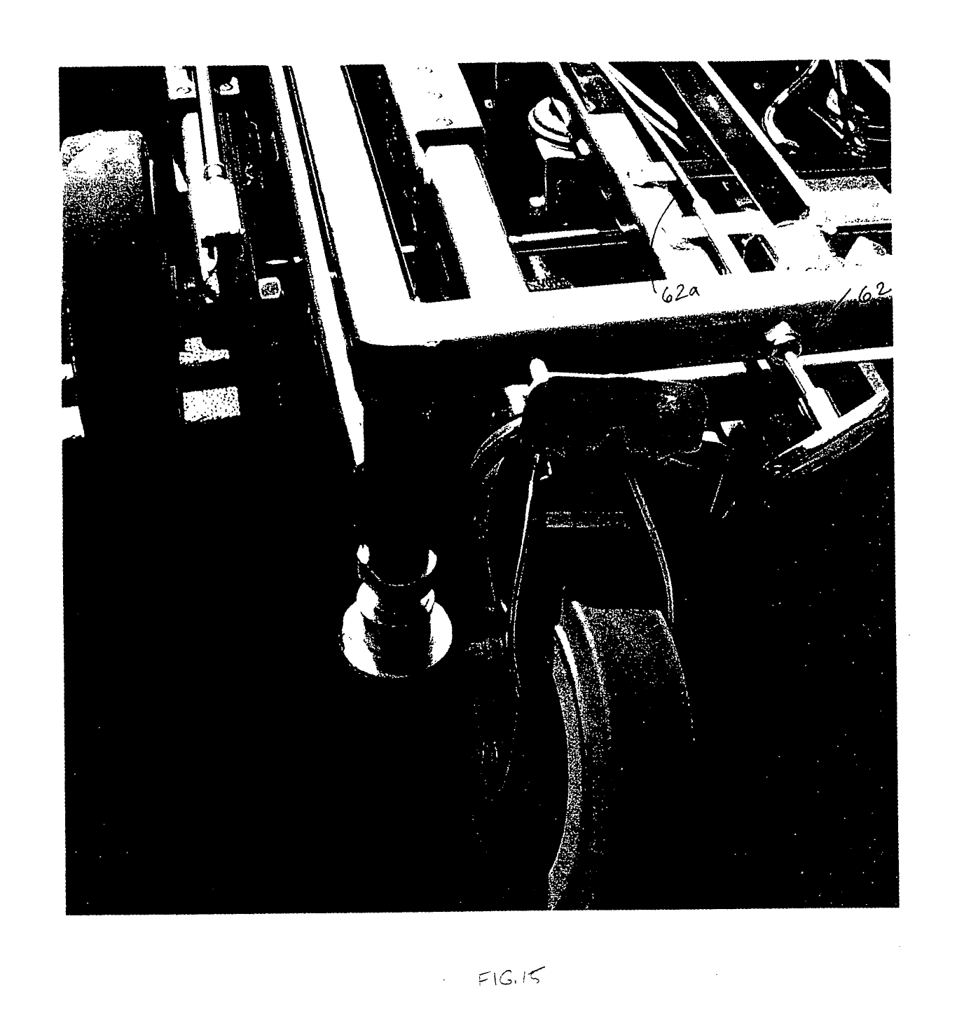

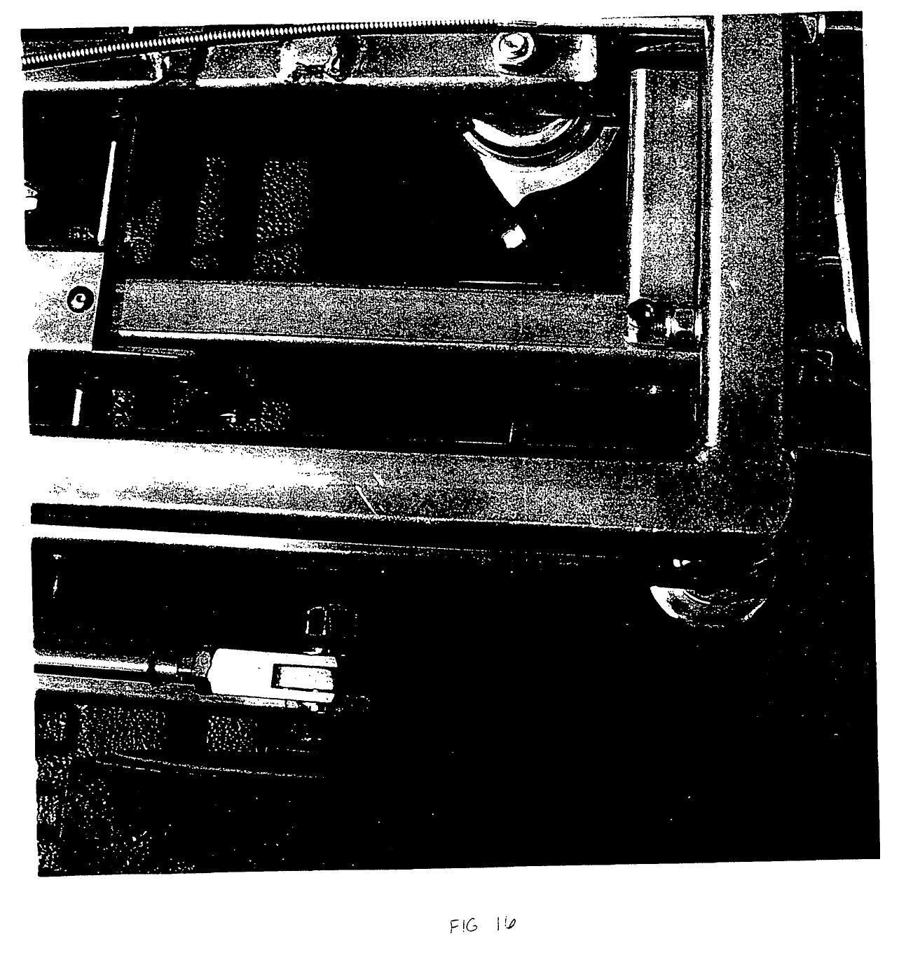

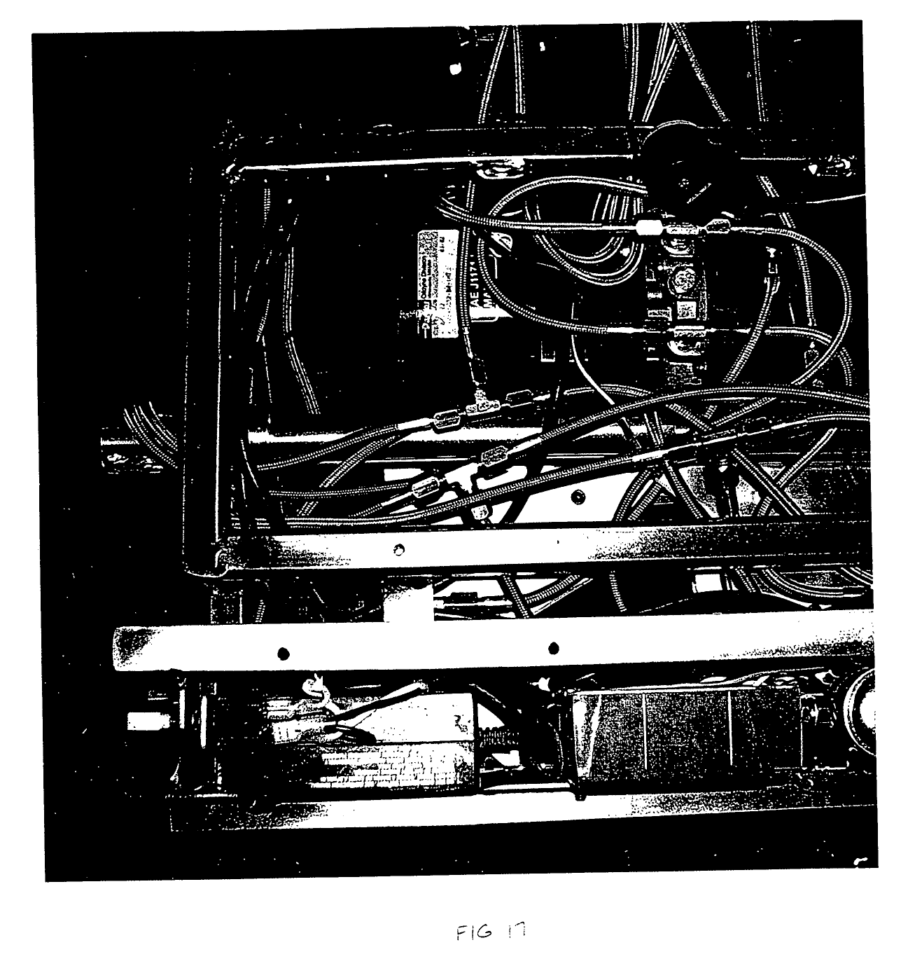

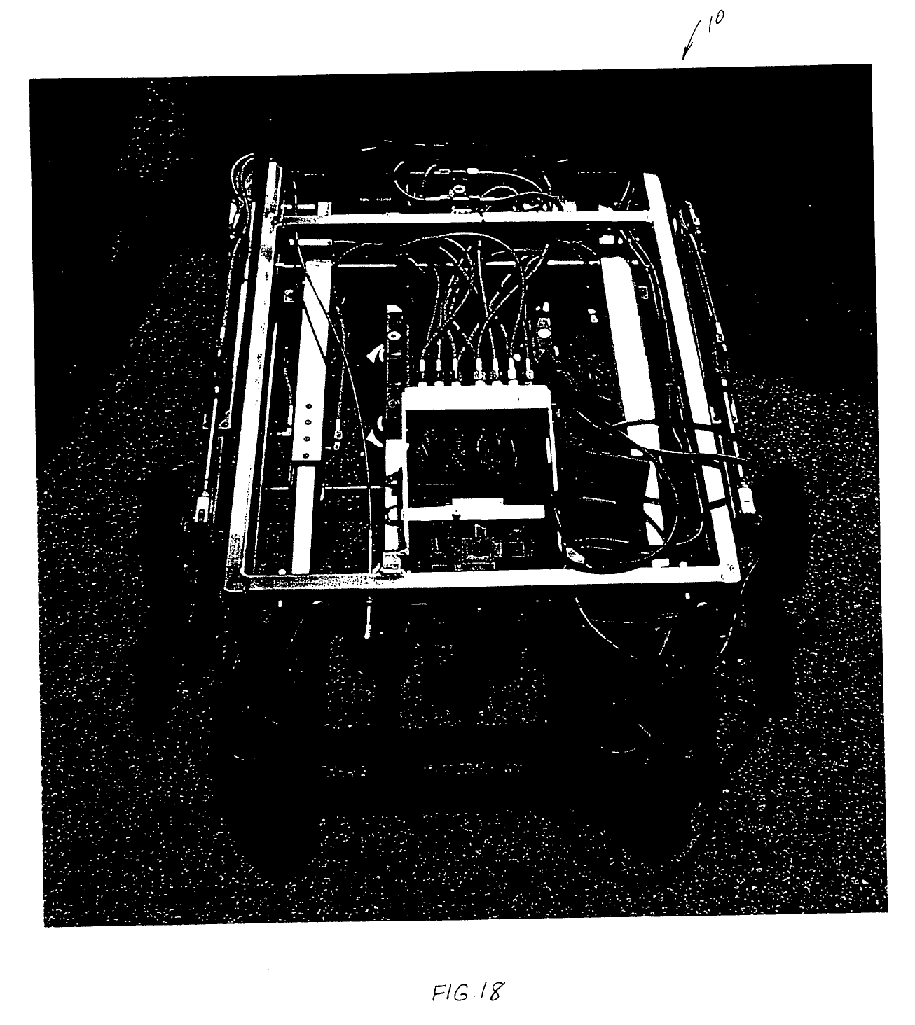

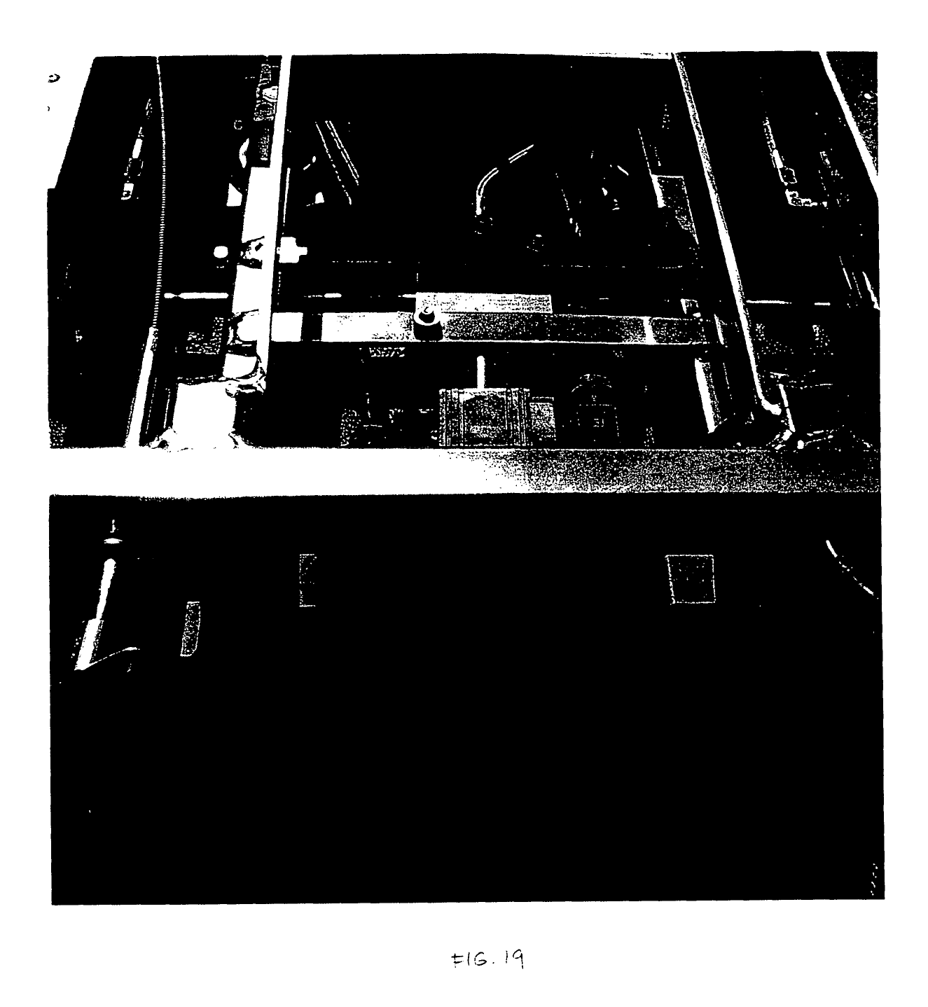

To ease on-board maneuvering of undercarriage 10, support base 18 is provided with a set of intermediate journaled guide members 48. In addition, intermediate journaled guide members 48 assist in the transferring of the weight of the undercarriage onto the support surface to further ease in the handling and maneuvering of the undercarriage onto the support surface. As best seen in FIGS. 8 and 14, intermediate journaled guide members 48 are mounted to intermediate horizontal members 20a (FIG. 8) forming lower frame 24 and, similar to the forward journaled guide members 44, are preferably swivel mounted to support base 18. Preferably, the center of gravity 50 (FIG. 20) of undercarriage 10 is at least at or near the center 52 of intermediate journaled guide members 48 or, more preferably, at least slightly forward of members 48 to further ease the handling and maneuvering of undercarriage 10.

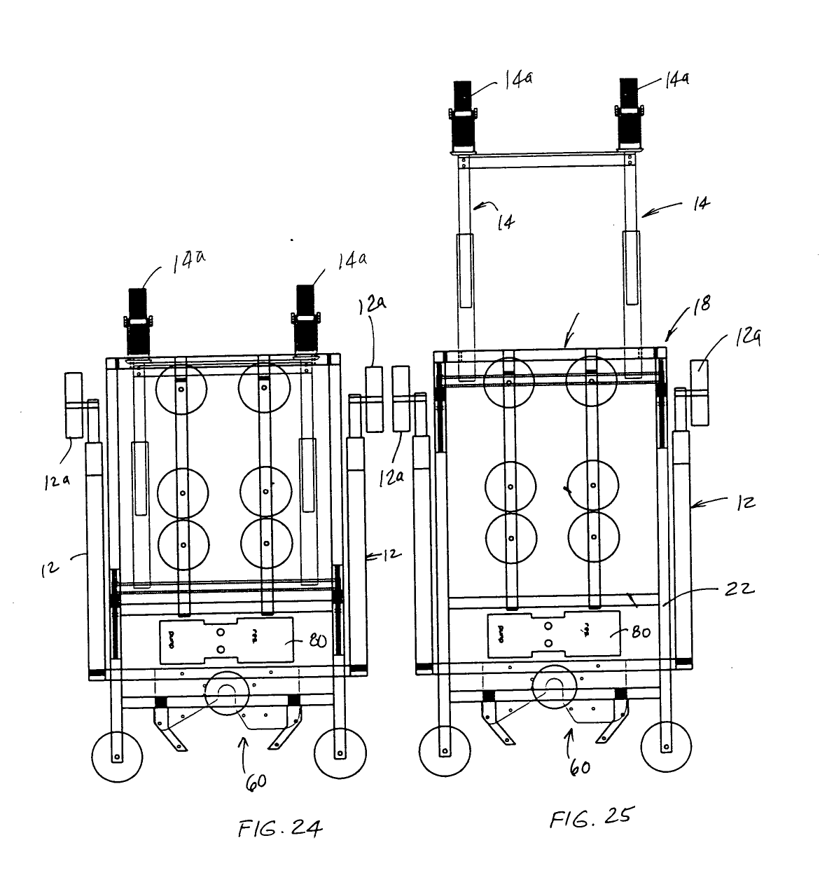

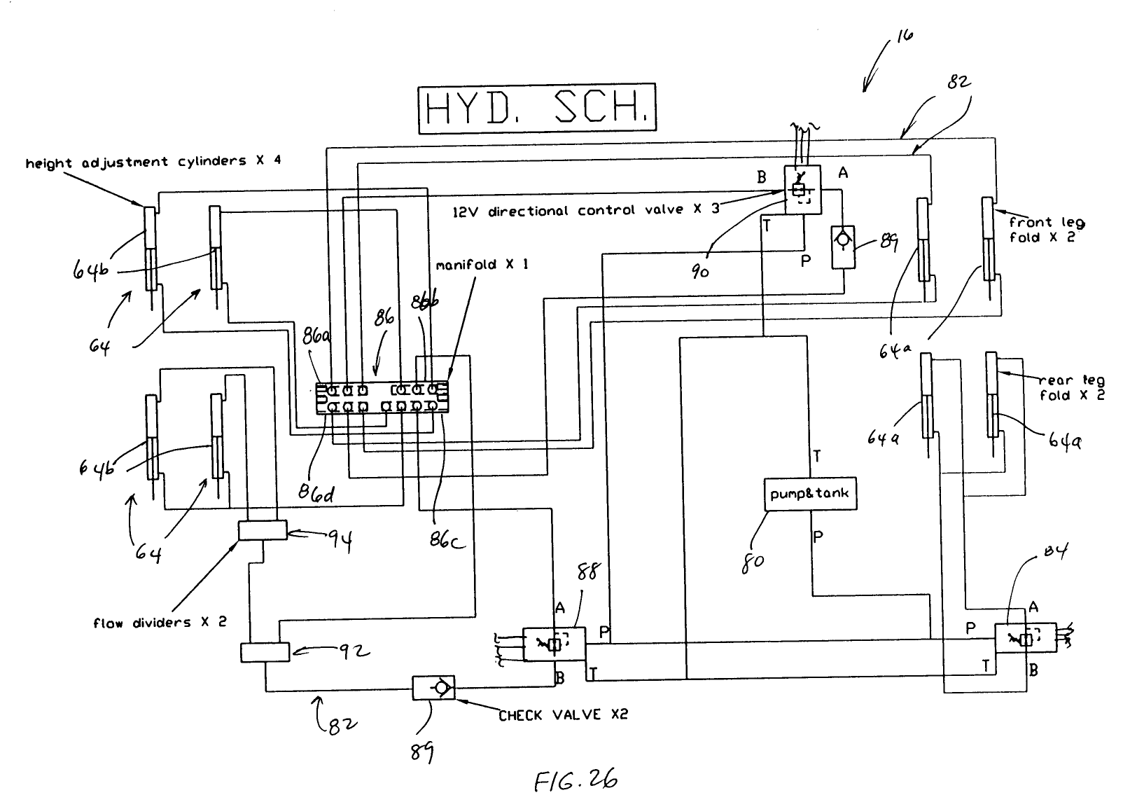

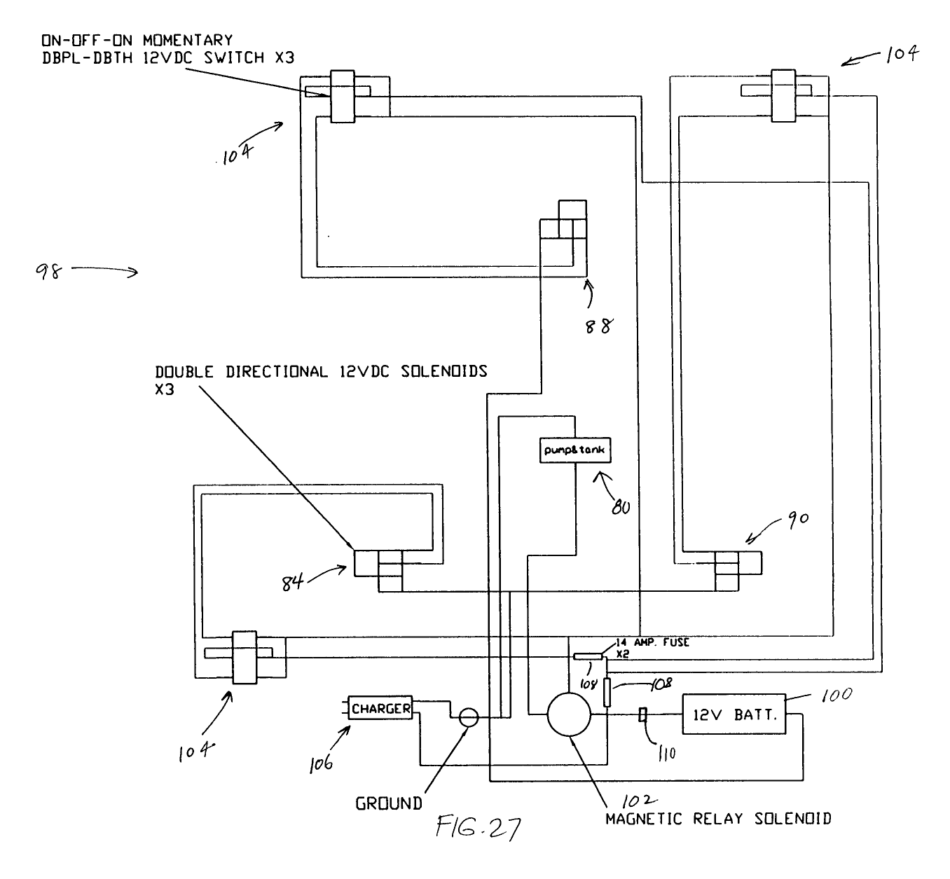

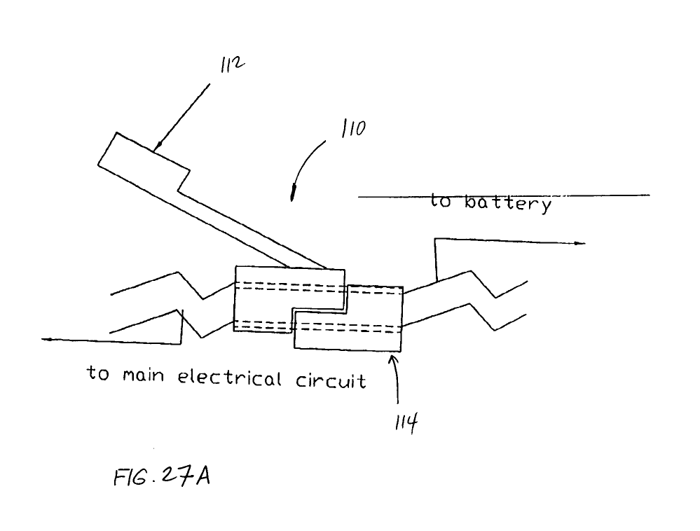

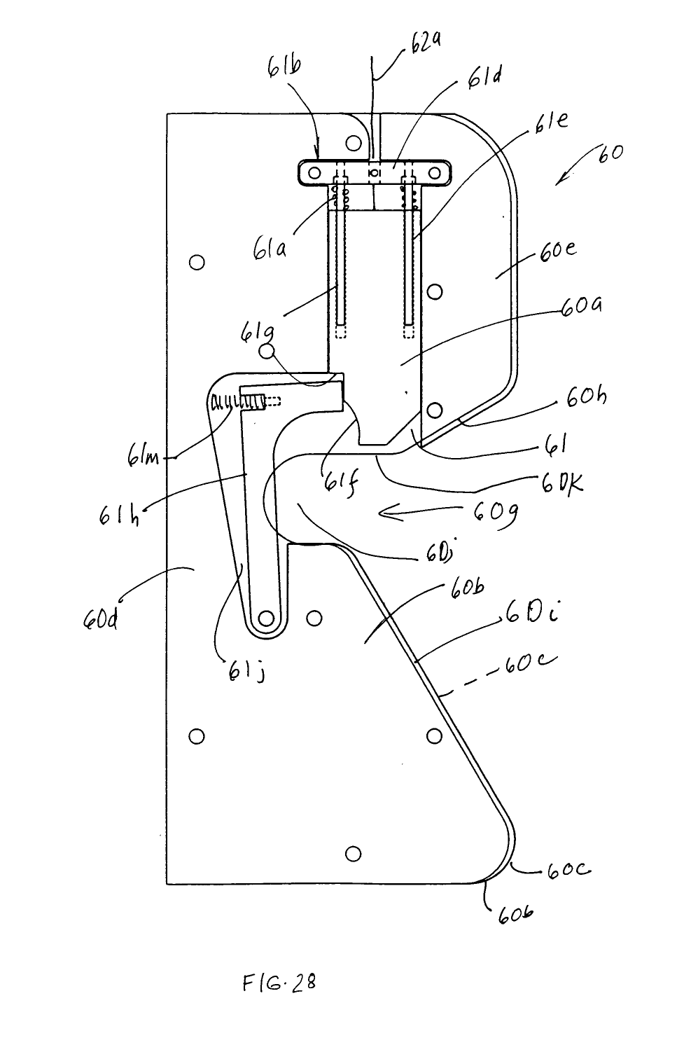

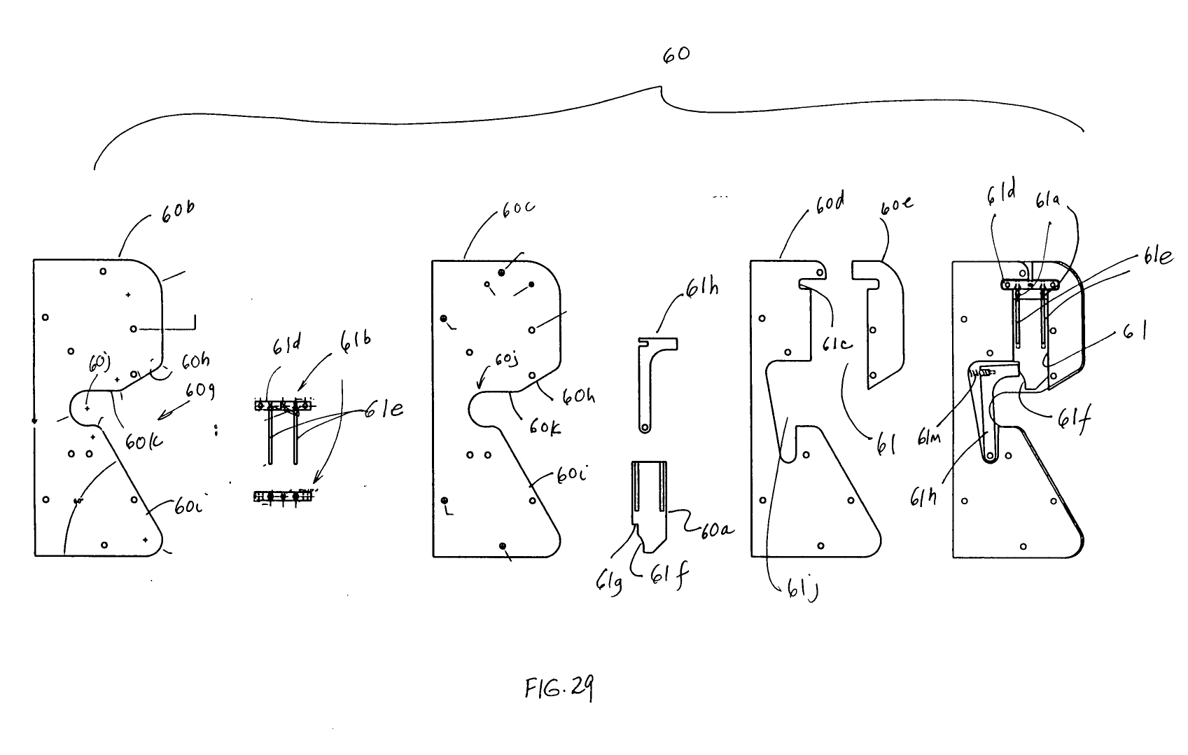

In addition, the rear end portion 10b of under carriage 10 includes a pair of journaled members 54, such as wheels, rollers, casters, or the like, mounted to support base 18 that provide support for the rear end of the undercarriage to further facilitate handling of the undercarriage. Optionally, rear end 10b also includes fixed supports or stanchions 56, preferably that are vertically adjustable, so that when undercarriage in a desired position on the support surface, they can be lowered to fix the position of the rear end of the undercarriage. To fix or anchor the forward portion of the undercarriage, forward portion includes a locking mechanism 60 (FIGS. 24 and 25) that is adapted to engage, for example, an anchor structure, such as a post, that is mounted to the floor of the vehicle. In a helicopter, the floor of the helicopter typically includes a cylindrical post that is anchored to the floor. In this manner, when the locking mechanism is engaged with and locked on to the post, the undercarriage is securely tied down in the helicopter.

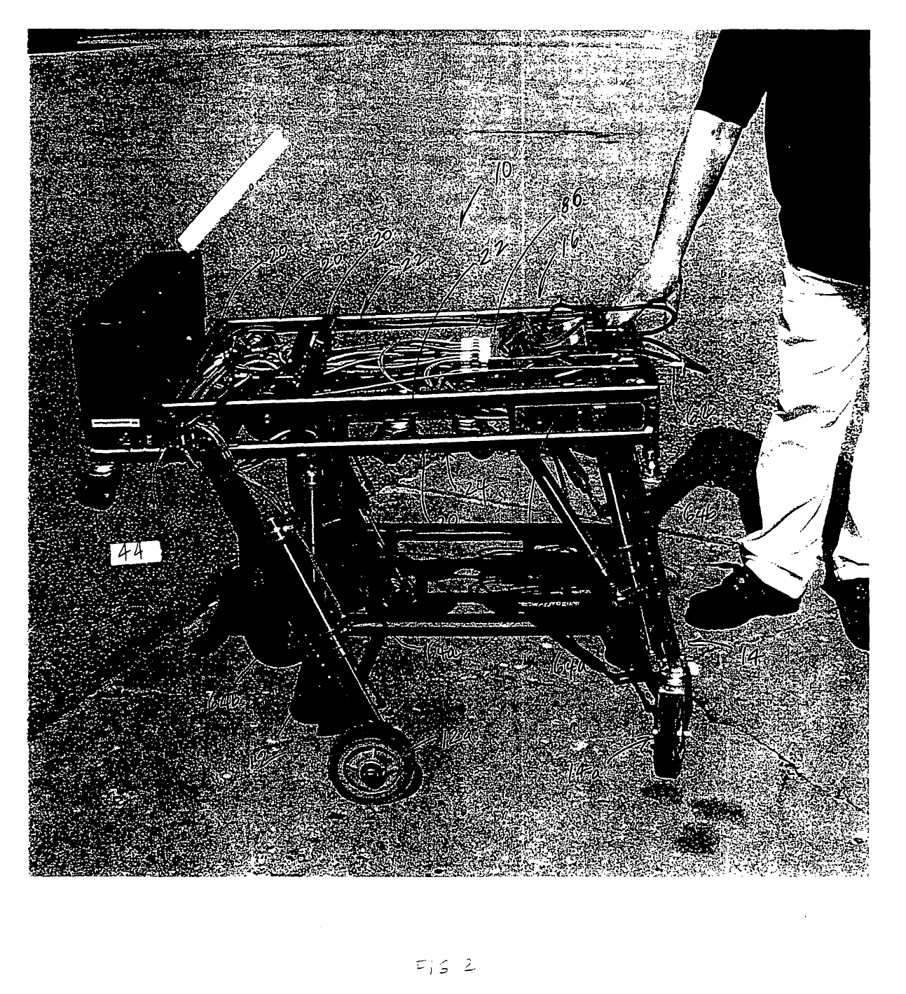

Referring to FIGS. 28 and 29, locking mechanism 60 includes a locking arm 60a that is actuated in to a locked position about the anchor structure when locking mechanism 60 is urged into engagement with the anchor structure. Arm 60a is released from its locked position upon actuation by a handle and cable assembly 62 (FIG. 2), which is preferably located at the rear end 106 of undercarriage 10. As best seen in FIG. 29, locking mechanism 60 includes upper and lower plates 60b and 60c and intermediate plates 60d and 60e that are sandwiched between upper an lower plates 60b and 60c. Plates 60b and 60c are preferably formed form a rigid material, such as metal, and, more preferably, from a light weight metal, such as aluminum. Intermediate plates 60d, 60e may be formed from a plastic material, such as ultra high molecular weight plastic, to thereby reduce the friction of the moving parts of locking mechanism 60 and are attached to upper and lower plates by fasteners or the like. In addition, plates 60d and 60e each have a greater thickness than either plate 60b or 60c so as to form a gap between plates 60b and 60c of sufficient height to house arm 60a and the various components described below, which are used to actuate arm 60a.

Each plate 60b and 60c has formed therein a recessed portion 60g that is preferably generally centrally located on one side of the respective plate. Recessed portion 60g includes angled walls 60h and 60i that guide the anchor structure, which is preferably a post, into a seat 60j that is formed at the juncture of the two angled walls. In the illustrated embodiment, seat 60j has a circular perimeter and a shoulder 60k; though it should be understood that the shape of the seat may be varied. As will be more fully described, when the anchor structure is moved into seat 60j, arm 60a is released and moved to its locked position behind the anchor structure to thereby lock onto the anchor structure.

As noted above, intermediate plates 60d, 60e are spaced apart and define therebetween a space or passageway 61 in which arm 60a is positioned and movably supported for extension into seat 60j though shoulder 60k so that when the anchor structure is positioned in seat 60j and arm 60a is moved to its extended position, arm 60a will lock undercarriage 10 onto the anchor structure until the arm 60a is released. As previously note, arm 60a is movably supported in the passageway defined between plates 60d, 60e and, further, is urge to its extended or locked position by springs 61a. Springs 61a are supported on a guide 61b that is mounted between plates 60d, 60e and located in corresponding recesses 61c that align guide 61b in passageway 61. Guide 61b includes a transverse member or base 61d that extends between recesses 61c and further supports a pair of guide pins 61e that extend into corresponding elongate recesses formed in arm 60a to provide a linear guide for arm 60a. Springs 61a are mounted on pins 61e and are compressed between transverse member 61d and the proximal end of arm 60a so that arm 60a is urged toward seat 60j. The distal end of arm 60a includes an engagement surface 61f, which optionally matches the surface topology of the anchor structure to reduce the play between the anchor structure and the locking mechanism. In the illustrated embodiment, engagement surface 61f is a curved surface to match the curved surface of the anchor structure. In addition, the distal end of arm 60a includes a shoulder 61g that is used to latch arm in its retracted position.

As best seen in FIG. 28, locking mechanism 60 includes a second arm 61h that is used to latch arm 60a in its retracted position and, further as will more fully explained below, to actuate arm 60a to move to its extended position. Second arm 61h is pivotally mounted between upper and lower arms 60b and 60c by a pin and is positioned in an inverted generally L-shaped passage 61j (as viewed in FIG. 29) formed in plate 60d. In addition, arm 61h is urged by a spring 61m to a pivoted position in which the distal end of arm 61h projects into passage 61 to engage shoulder 61g of arm 60a to thereby latch arm 60a in its retracted position. Spring 61m is mounted on one end to plate 60d and extends into and is captured in a recess formed in arm 61h. In its rested state, arm 61h is extended into passage 61, but is moved to its retracted position in passage 61j when compressed by the anchor structure. When moved to its retracted position, arm 61h disengages from arm 60a to thereby release arm 60a so that arm 60a can be extended behind the anchor structure to thereby lock undercarriage onto the anchor structure. Arm 60a is unlocked when cable 62a is tensioned sufficiently to move arm 60a against the force of springs 61a.

As previously noted, legs 12 and 14 are pivoted to their stowed positions and, further, are actuated to extend in length by control system 16. Control system 16 comprises a remote control system in that the actuators that impart the rotation and lengthening of the respective legs are controlled by controllers remote from the actuators, though the remote controllers are preferably mounted on the undercarriage or to the stretcher base. In the illustrated embodiment, control system 16 comprises a hydraulic system, which enables both pairs of legs to independently extend and retract for raising and lowering the support base 18 for raising and lowering a patient's position, as well as pivot about their respective pivot axes for loading the undercarriage onto a vehicle. As best seen in FIGS. 2, 3, 4, and 26, control system, 16 includes a plurality of actuators 64. Optionally, each leg 12, 14 includes two actuators—a pivot actuator 64a for pivoting the respective leg and a height adjustment actuator 64b for lengthening or shortening the respective leg. Each rearward leg 14 includes a mounting flange or tab 66 to which the distal end of pivoting actuator 64a is mounted. In the case of the rearward legs, the distal ends of the pivoting actuators are mounted to brace 12b and the proximal ends of pivoting actuators 64a are mounted to the respective brackets 32 and 34.

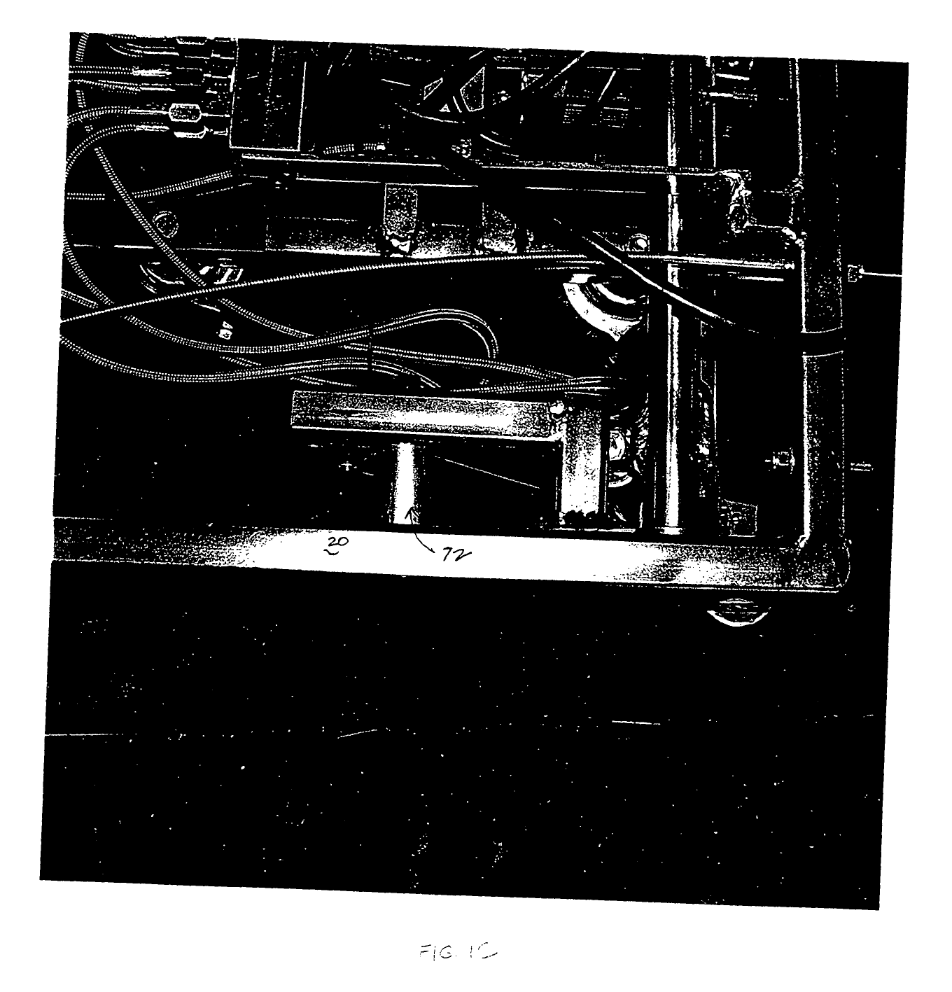

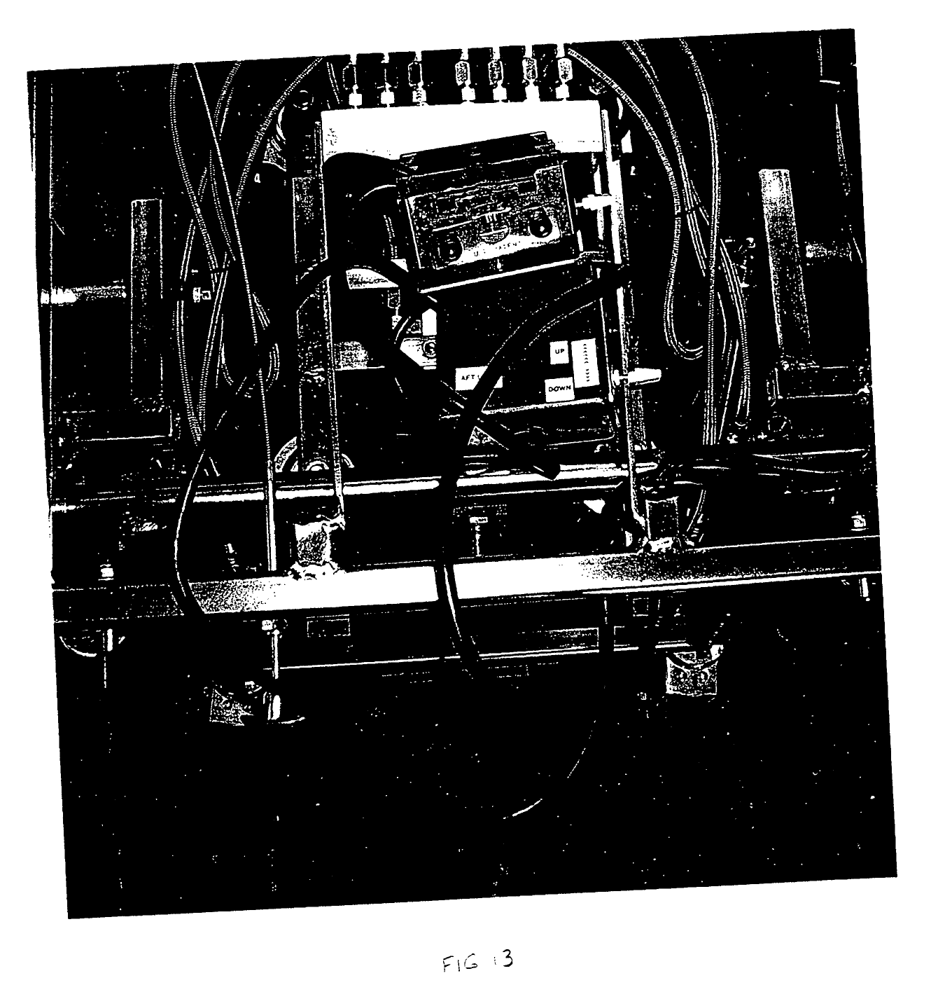

As best seen in FIG. 12, each bracket 32, 34 includes mounted thereto a support that extends inwardly from horizontal members 20 of lower frame 24 and forward of pivot shaft 30 of rearward legs 14. The distal ends of pivot cylinders 64a of rearward legs 14 are mounted to brackets 34 and 36 at supports 72 by brackets 74. Thus, in the case of the rearward legs 14, pivot actuators 64a are extended to pivot the rearward legs to their pivoted positions. With respect to pivot cylinders 64a of the forward legs 12, the proximal ends of pivot cylinders 64a are mounted to horizontal members 20 of lower frame 24 by brackets 70, which are directly mounted to the lower frame 24 but mounted rearward of legs 12. Thus in the case of the forward legs, pivot actuators 64a are retracted to pivot the respective front legs to their pivoted and also stowed positions. In the illustrated embodiment, supports 72 comprise tubular L-shaped members; however it should understood that supports 72 may have other configurations.

In the illustrated embodiment, each leg 12, 14 comprises a telescoping leg, with an outer tubular member 12c, 14c and an inner tubular member 12d, 14d. For example, the inner tubular members may be mounted inside the respective outer tubular members on bearings, which permit extension and retraction of the inner tubular member relative to the outer tubular member while maintaining the relative play between the two members at acceptable levels, as would be known in the art. Height adjustment actuators 64b are mounted at their distal ends to inner tubular members 12d, 14d, while their proximal ends are mounted to the respective outer tubular members 12c, 14c to permit adjustment of the length of the respective legs. Preferably, the respective outer and inner tubular members of the legs are provided with tabs or mounting flanges 78, 80 to which the height adjustment actuators 64b are mounted. In this manner, when a height adjustment actuator 64b is extended, inner tubular member 12d, 14d is extended with respect to the outer tubular member 12c, 14c to thereby lengthen the respective leg. Optionally, pivot actuators 64a and adjustment actuators 64b may be independently controlled so that each leg can be independently adjusted. However to minimize potential for binding and for ease of control, pivot actuators 64a of forward legs are actuated together, and pivot actuators 64a of rearward legs 14 are actuated together. Similarly, to maintain support base 18 level, adjustment actuators of both pairs of legs are preferably actuated together. However, it should be understood that control system 16 may be configured to adjust each leg independently.

In the illustrated embodiment, pivot actuators 64a and adjustment actuators 64b comprise cylinders and preferably hydraulic cylinders 66a and 66b. Preferably cylinders 66a and 66b are double acting cylinders and are connected to a pump and tank 80 through tubes or conduits 82, which deliver and receive hydraulic fluid from pump and tank 80 to the respective cylinders to thereby selectively extend or retract the rod end of the respective cylinders to control the position and/or length of the respective legs. Hydraulic fluid is delivered from the tank through the pump to pivot cylinders 64a of rear legs 14 through a control valve, preferably a solenoid valve 84. Pump and tank 80 also deliver fluid to pivot cylinders 64a of front legs 12 and the adjustment cylinders 64b of both front and rear legs 12, 14 though a manifold 86 and a pair of solenoid valves 88 and 90, which are connected in parallel to manifold 86, to deliver fluid to the respective cylinders. Solenoid valves 84, 88, and 90 preferably comprise double directional solenoid valves so that the hydraulic fluid can flow either way through the solenoid valve to permit delivery of fluid to either end of the respective double-acting cylinder. In the illustrated embodiment, manifold 86 has four chambers or compartments—one compartment 86a for delivering to or receiving hydraulic fluid from one end of pivot cylinders 64a for the front legs 12; a second compartment 86b for delivering to or receiving hydraulic fluid from one end of the adjustment cylinders 64b of the front legs 12; a third chamber 86c for delivering to or receiving hydraulic fluid from the other end of the pivot cylinders 64a of the front legs 12; and a fourth chamber for delivering to or receiving hydraulic fluid from the other ends of the adjustment cylinders 64b of both the front and rear legs 12, 14. In addition, control system 16 includes a pair of flow dividers 92 and 94 to hydraulically couple the front and rear adjustment cylinders together and to hydraulically couple the left and right adjustment cylinders together to assure that the support base moves up and down evenly. Solenoid valve 88 directs the hydraulic fluid to flow dividers 92 and 94 from pump and tank 80. Though, as mentioned before, it should be understood that cylinders 66b can be independently controlled. Solenoid valves 84, 88, and 90 permit the pressure in the pump to charge the respective pivot cylinders and adjustment cylinders and are controlled by an electrical control circuit described below. Optionally, control system 16 may include one or more check valves 89 to prevent pressure drop in respective conduit 82 that delivers fluid from valves 88, 90 to manifold 86 due to leakage that may occur in the solenoid valves.

The electrical control circuit 98 of control system 16 includes a power source 100, such as a 12-volt battery, a relay, such as a magnetic relay solenoid, which acts as a switch 102, and a plurality of remote controllers or control switches 104. Control switches 104 preferably comprise on-off-on momentary switches, which are commercially available. Switch 102 controls the delivery of power to pump 80. As noted above, remote controllers 104 may be mounted to the undercarriage or to the stretcher base, preferably at the rear end of the undercarriage to provide easy access to the person handling the undercarriage. Controllers 104 control the delivery of power to the respective solenoid valves 84, 88, and 90 to thereby control the flow of hydraulic fluid to and from the respective cylinders 66a, 66b to and from the tank and pump 80 to thereby control the position and/or length of the respective legs. Optionally, solenoid valves 84, 88, and 90 are provided with a mechanical override actuator, such as button, so that in the event of a power supply failure, the person maneuvering the system can manually control the flow of fluid through the solenoid valves to control the extension or retraction of the cylinders to thereby transfer the undercarriage and stretcher on to the desired support surface, such as the floor of a helicopter. In addition, circuit 98 preferably includes a charger 106, which recharges battery 100 when charger 106 is coupled to the vehicle's electrical system. As in most circuits, circuit 98 optionally includes overdraw protection, such as fuses 108. In addition, circuit 98 preferably includes an emergency disconnect 10 (FIGS. 27 and 27A). Disconnect 10 includes a handle 112 and an electrical connection 114 that is positioned between battery 100 and the main electrical circuit, which is broken when handle 112 is pulled to disconnect the main circuit from the battery as would be understood by those skilled in the art. The handle is preferably located at the rearward end of undercarriage 10, though it may be located elsewhere.

While several forms of the invention have been shown or described, other forms will now be apparent to those skilled in the art. While the hydraulic circuit incorporates the use of a manifold to direct the flow of hydraulic fluid to the various solenoid valves, the manifold may be eliminated with each of the solenoid valves directly connected to the tank and pump. However, in an effort to save space and reduce congestion, the use of a manifold valve or equivalent is desirable, though not necessary. In addition, though the control circuit has been described in reference to an electrical/hydraulic system, the control system may be pneumatic over hydraulic or a pure electrical system. For example, the control system may include electrical actuators, such as servo motors, including linear motors, or the like. Therefore, it will be understood that the embodiments shown in the drawings and described above are merely for illustrative purposes, and are not intended to limit the scope of the invention, which is defined by the claims, which follow as interpreted under the principles of patent law including the doctrine of equivalents.

The embodiments of the invention in which an exclusive property right or privilege is claimed are defined as follows:

1. An undercarriage for transporting a stretcher, said undercarriage comprising:
a support base adapted for supporting a stretcher, said support base having an open compartment and defining an upper plane bounded by an upper surface of said support base and a lower plane bounded by a lower surface of said support base;
a first pair of legs pivotally mounted to the support base, each of said first pair of legs comprising a forward leg;
a second pair of legs pivotally and slidably mounted to the support base, each of said second pair of legs comprising a rearward leg, said first pair of legs being independently pivotal about said support base from said second pair of legs;
a journaled member provided at the distal ends of each leg; and
a control system adapted to selectively pivot said first pair of legs to a stowed position and to selectively pivot said second pair of legs to a stowed position, and said control system further adapted to selectively lengthen or shorten said legs to adjust the height of said support base.

2. The undercarriage according to claim 1, wherein said stowed position of said first pair of legs is between said upper and lower planes.

3. The undercarriage according to claim 1, wherein said stowed position of said second pair of legs is between said upper and lower planes.

4. The undercarriage according to claim 1, wherein said second pair of legs at least partially extend into said open compartment when moved to their stowed position.

5. The undercarriage according to claim 1, wherein said support base includes a plurality of journaled members, said journaled members of said support base enabling a person move said undercarriage across a support surface when said support base is extended over the support surface.

6. The undercarriage according to claim 5, wherein a group of said journaled members are located at a forward end of said support base to form forward journaled members.

7. The undercarriage according to claim 5, wherein a group of said journaled members of said support base are located forward of said rearward legs and rearward of said forward legs to form intermediate journaled members wherein said intermediate journaled members provide support for said undercarriage when said forward legs are pivoted to their stowed position to thereby ease handling of said undercarriage.

8. The undercarriage according to claim 7, wherein said undercarriage has a center of gravity, said intermediate journaled members located at or near said center of gravity.

9. The undercarriage according to claim 7, wherein said undercarriage has a center of gravity, said intermediate journaled members are located rearward of said center of gravity.

10. The undercarriage according to claim 1, wherein said control system includes a plurality of actuators, said actuators pivoting and adjusting the length of said legs.

11. The undercarriage according to claim 10, wherein said actuators comprise cylinders.

12. The undercarriage according to claim 11, wherein said cylinders comprise hydraulic cylinders.

13. The undercarriage according to claim 10, each of said legs includes a pivot actuator and a height adjustment actuator wherein said pivoting and said adjusting the length of said legs is independent.

14. The undercarriage according to claim 13, wherein said adjustment actuators are coupled.

15. The undercarriage according to claim 14, wherein said actuators comprise hydraulic cylinders.

16. The undercarriage according to claim 15, wherein said cylinders are hydraulically coupled.

17. An undercarriage for transporting a stretcher, said undercarriage comprising:
a support base adapted for supporting a stretcher, said support base having a frame;
a first pair of legs pivotally mounted to opposed sides of said frame, each of said first pair of legs comprising a forward leg;
a second pair of legs pivotally and slidably mounted to said frame and being extendible into said frame, each of said second pair of legs comprising a rearward leg, said first pair of legs being independently pivotal about said frame from said second pair of legs;
a journaled member provided at the distal ends of each leg; and
a control system adapted to selectively pivot said first pair of legs to a stowed position and to selectively pivot said second pair of legs to a stowed position in said frame.

18. The undercarriage according to claim 17, wherein said control system is further adapted to selectively lengthen or shorten said legs to adjust the height of said support base.

19. The undercarriage according to claim 17, wherein said control system includes a plurality of actuators, said actuators pivoting said legs.

20. The undercarriage according to claim 19, wherein said actuators comprise hydraulic cylinders.

21. The undercarriage according to claim 20, wherein each of said legs includes a cylinder, wherein said cylinders of said front legs are hydraulically coupled wherein said front legs pivot substantially in unison.

22. The undercarriage according to claim 21, wherein said hydraulic cylinders of said front legs are physically coupled.

23. The undercarriage according to claim 20, wherein said cylinders of said rear legs are hydraulically coupled wherein said rear legs pivot substantially in unison.

24. The undercarriage according to claim 19, wherein each of said legs includes a pivot actuator and a height adjustment actuator, said adjustment actuators for adjusting the length of said legs wherein the height of said support base can be adjusted.

25. The undercarriage according to claim 24, wherein said pivoting and said height adjusting is independent.

26. The undercarriage according to claim 24, wherein said height adjustment actuators of at least said front legs are coupled wherein said front legs lengthen substantially in unison.

27. The undercarriage according to claim 17, wherein said support base includes a plurality of journaled members, said journaled members of said support base enabling a person to translate said undercarriage across a support surface when said first pair of legs are pivoted to their stowed position.
